(19) United States
(12) Patent Application Publication
(10) Pub. No.: US 2024/0342607 A1
(43) Pub. Date: Oct. 17, 2024

(54) VIRTUAL OBJECT INTERACTION METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Zhuocheng ZOU, Shenzhen (CN)

(21) Appl. No.: 18/754,002

(22) Filed: Jun. 25, 2024

Related U.S. Application Data
(63) Continuation of application No. PCT/CN2023/085788, filed on Mar. 31, 2023.

(30) Foreign Application Priority Data
May 31, 2022 (CN) 202210611101.7

(51) Int. Cl. A63F 13/56; A63F 13/537; A63F 13/69; G06T 13/40; G06T 19/20

(52) U.S. Cl. CPC A63F 13/56; A63F 13/537; A63F 13/69; G06T 13/40; G06T 19/20; G06T 2219/2004

(57) ABSTRACT

A virtual object interaction method is performed by a computer device. The method includes: displaying a first virtual object and a second virtual object in a virtual scene; in response to an interactive operation by a user of the computer device, controlling the first virtual object to perform an interactive activity with the second virtual object in the virtual scene; displaying a special effect text element according to an interaction result between the first virtual object and the second virtual object; and displaying a conversion and drop animation in which the special effect text element is converted into a specified item and dropped into the virtual scene. Thus the special effect text element is displayed according to the interaction result, and an animation is displayed in which the special effect text element is converted into the specified item, so that user interaction experience is improved.

### CROSS-REFERENCE TO RELATED APPLICATIONS

This application is a continuation application of PCT Patent Application No. PCT/CN2023/085788, entitled “VIRTUAL OBJECT INTERACTION METHOD AND APPARATUS, DEVICE, STORAGE MEDIUM, AND PROGRAM PRODUCT” filed on Mar. 31, 2023, which claims priority to Chinese Patent Application No. 202210611101.7, entitled “VIRTUAL OBJECT INTERACTION METHOD AND APPARATUS, DEVICE, STORAGE MEDIUM, AND PROGRAM PRODUCT” filed on May 31, 2022, both of which are incorporated herein by reference in their entirety.

### FIELD OF THE TECHNOLOGY

Embodiments of this application relate to the field of virtual environment technologies, and in particular, to a virtual object interaction method and apparatus, a device, a storage medium, and a program product.

### BACKGROUND OF THE DISCLOSURE

With the rapid development of computer technologies and the diversification of terminal devices, applications of electronic games are gradually widespread. A fighting game is a popular game in which a terminal device can display a virtual scene, and a user can control a virtual object to perform a virtual battle with another virtual object in the virtual scene to win the game.

In the related art, data of virtual objects controlled by two players and attribute values of the virtual objects are displayed in a virtual environment picture corresponding to the virtual scene. When a virtual object controlled by a player and an opponent virtual object controller by another player perform a game battle, if the virtual object controlled by the player attacks and hits the opponent virtual object, an attribute value of the opponent virtual object is reduced, to indicate that the opponent virtual object is hit by this attack and the attribute value is reduced.

However, in the related art, whether the attribute value of the opponent virtual object is reduced is determined only by determining whether the opponent virtual object is hit by the attack operation, and an interaction display manner in the game is simple.

### SUMMARY

Embodiments of this application provide a virtual object interaction method and apparatus, a device, a storage medium, and a program product, to improve diversity of display manners of interaction and interaction between virtual objects. The technical solutions are as follows.

According to an aspect, a virtual object interaction method is performed by a computer device, the method including:
displaying a first virtual object and a second virtual object in a virtual scene;
in response to an interactive operation by a user of the computer device, controlling the first virtual object to perform an interactive activity with the second virtual object in the virtual scene;
displaying a special effect text element in the virtual scene according to an interaction result between the first virtual object and the second virtual object; and
displaying a conversion and drop animation in which the special effect text element is converted into a specified item and dropped into the virtual scene.

According to another aspect, a computer device is provided, including a processor and a memory, the memory storing a computer program, the computer program, when executed by the processor, causing the computer device to implement the foregoing virtual object interaction method.

According to another aspect, a non-transitory computer-readable storage medium is provided, storing a computer program, the computer program, when executed by a processor of a computer device, causing the computer device to implement the foregoing virtual object interaction method.

The technical solutions provided in this application include at least the following beneficial effects.

When a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

### BRIEF DESCRIPTION OF THE DRAWINGS

FIG. 1 is a schematic diagram of a virtual object interaction method according to the related art.

FIG. 2 is a schematic diagram of a virtual object interaction method according to an exemplary embodiment of this application.

FIG. 3 is a structural block diagram of an electronic device according to an exemplary embodiment of this application.

FIG. 4 is a schematic diagram of a solution implementation environment according to an exemplary embodiment of this application.

FIG. 5 is a flowchart of a virtual object interaction method according to an exemplary embodiment of this application.

FIG. 6 is a flowchart of a virtual object interaction method according to another exemplary embodiment of this application.

FIG. 7 is a schematic diagram of a special effect text element content display method according to an exemplary embodiment of this application.

FIG. 8 is a schematic diagram of a special effect text element content display method according to another exemplary embodiment of this application.

FIG. 9 is a schematic diagram of a specified item generation process according to an exemplary embodiment of this application.

FIG. 10 is a schematic diagram of a specified item generation process according to another exemplary embodiment of this application.

FIG. 11 is a schematic diagram of a specified item pick-up process according to an exemplary embodiment of this application.

FIG. 12 is a flowchart of a virtual object interaction method according to another exemplary embodiment of this application.

FIG. 13 is a schematic diagram of a buff effect display manner according to an exemplary embodiment of this application.

FIG. 14 is a schematic diagram of an attribute value-adding animation according to an exemplary embodiment of this application.

FIG. 15 is a flowchart of a virtual object interaction method according to another exemplary embodiment of this application.

FIG. 16 is a schematic diagram of a first movement animation according to an exemplary embodiment of this application.

FIG. 17 is a schematic diagram of a buff selection interface according to an exemplary embodiment of this application.

FIG. 18 is a schematic diagram of an item integration process according to an exemplary embodiment of this application.

FIG. 19 is a flowchart of a virtual object interaction method according to another exemplary embodiment of this application.

FIG. 20 is a flowchart of a virtual object interaction method according to another exemplary embodiment of this application.

FIG. 21 is a structural block diagram of a virtual object interaction apparatus according to an exemplary embodiment of this application.

FIG. 22 is a structural block diagram of a virtual object interaction apparatus according to another exemplary embodiment of this application.

FIG. 23 is a structural block diagram of a terminal device according to an exemplary embodiment of this application.

### DESCRIPTION OF EMBODIMENTS

To make objectives, technical solutions, and advantages of this application clearer, the following further describes implementations of this application in detail with reference to the accompanying drawings.

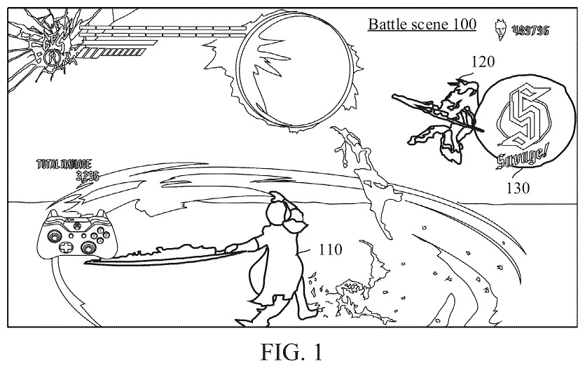

Referring to FIG. 1, FIG. 1 is a schematic diagram of a virtual object interaction method according to the related art. As shown in FIG. 1, in the related art, an example in which a virtual scene is implemented as a battle scene 100 is used. The battle scene 100 includes a first virtual object 110 controlled by a player and a second virtual object 120 controlled by another player. The first virtual object 110 and the second virtual object 120 perform a virtual battle. After the first virtual object 110 successively hits the second virtual object 120 by using an attack skill, a combo label 130 corresponding to the successive hit of the attack skill is displayed in the battle scene 100. The combo label 130 is implemented as describing a quantity of successive hits (for example, the quantity of successive hits is five) that the first virtual object 110 successively hits the second virtual object 120 by using the attack skill currently, to display a battle result between the first virtual object 110 and the second virtual object 120.

However, in the related art, when two virtual objects perform a game battle, a manner of specially displaying only a quantity of successive hits of a virtual object can allow a player to learn only a corresponding current attack result after an attack is performed by using an attack skill, and cannot substantially make the player better aware of a hitting effect. As a result, a game accomplishment sense of a high-end player is relatively low, and a current interaction manner between virtual objects is only displayed in a single special effect form, resulting in low interaction between players.

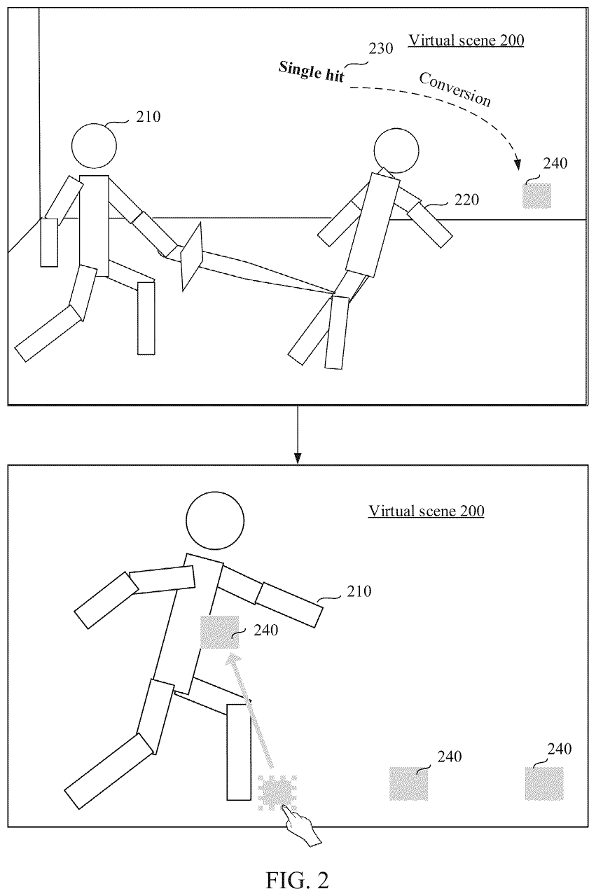

FIG. 2 is a schematic diagram of a virtual object interaction method according to an exemplary embodiment of this application. In the virtual object interaction method provided in this embodiment of this application, a virtual scene 200 includes a first virtual object 210 and a second virtual object 220. A process of performing a specified interactive activity between the first virtual object 210 and the second virtual object 220 is displayed in response to an interactive operation performed by a player. The specified interactive activity may be implemented as performing a game battle between the first virtual object 210 and the second virtual object 220 by using a skill.

An interaction result between the first virtual object 210 and the second virtual object 220 may be implemented as follows: When the first virtual object 210 attacks the second virtual object 220 by using a skill and hits the second virtual object 220, a special effect text element 230 is displayed at a specified location corresponding to the second virtual object 220. The current special effect text element 230 is implemented as “single hit”, configured for indicating that the first virtual object 210 attacks and hits the second virtual object 220 for the first time.

Then, a conversion and drop animation of the special effect text element 230 may be further displayed in the virtual scene 200. The conversion and drop animation is that “single hit” font are converted into a specified item 240 and the specified item 240 drops into the virtual scene 200. In this case, the player may control, by using a pick-up operation, the first virtual object 210 to pick up the specified item 240 in the virtual scene 200.

Based on the foregoing, compared with the related art, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text clement is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In some embodiments, the technical solutions provided in the embodiments of this application may be independently implemented by a terminal device, the technical solutions provided in the embodiments may be independently implemented by a server, or the technical solutions provided in the embodiments may be jointly implemented by the terminal device and the server. This is not limited in the embodiments of this application.

Because the implementation of the terminal device is the same as the implementation of the server, the implementation of the terminal device is used as an example in the embodiments of this application. The terminal device runs a target application supporting a virtual environment. The target application may be a standalone application, for example, a standalone 3D game program, or may be an online application or the like.

In this embodiment of this application, an example in which the target application installed in the terminal device is the standalone application is used. In this case, when the target application is run on the terminal device, the terminal device displays a virtual scene. The virtual scene includes a first virtual object and a second virtual object. When the first virtual object and the second virtual object perform a specified interactive activity according to an interactive operation, a client of the target application displays a special effect text element according to an interaction result between the first virtual object and the second virtual object, and displays a conversion and drop animation in which the special effect text element is converted into a specified item and the specified item drops into the virtual scene. A user may control, by using a pick-up operation on the terminal device, the first virtual object to pick up the specified item in the virtual scene.

In some embodiments, the terminal device may be an electronic device like a desktop computer, a portable laptop computer, a mobile phone, a tablet computer, an ebook reader, a moving picture experts group audio layer III (MP3) player, a moving picture experts group audio layer IV (MP4) player, or the like.

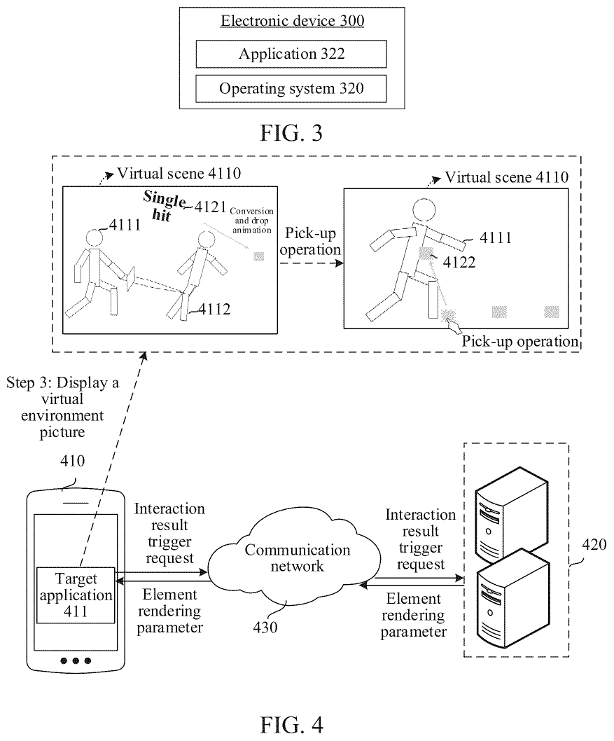

For example, FIG. 3 is a structural block diagram of an electronic device according to an exemplary embodiment of this application. The electronic device 300 includes: an operating system 320 and an application 322. The operating system 320 is basic software provided for the application 322 to perform secure access to computer hardware. The application 322 is an application supporting a virtual environment. In some embodiments, the application 322 is an application supporting a three-dimensional virtual environment. The application 322 may be any one of a virtual reality application, a 3D map program, an auto chess game, a puzzle video game, a fighting game, a third-person shooting (TPS) game, a first-person shooting (FPS) game, a multiplayer online battle arena (MOBA) game, or a multiplayer gunfight survival game. The application 322 may be a standalone application, for example, a standalone 3D game program, or may be an online application. This is not limited in this embodiment of this application.

In some embodiments, the technical solutions provided in the embodiments of this application may be jointly implemented by the terminal device and the server. For example, FIG. 4 is a schematic diagram of a solution implementation environment according to an embodiment of this application. As shown in FIG. 4, the implementation environment includes a terminal device 410, a server 420, and a communication network 430. The terminal device 410 is connected to the server 420 through the communication network 430.

A target application 411 supporting a virtual scene is run on the terminal device 410. A fighting game is used as an example. As shown in FIG. 4, when a current target application is implemented as an online application, the terminal device 410 currently displays a virtual scene 4110 corresponding to the target application 411. The virtual scene 4110 includes a first virtual object 4111 and a second virtual object 4112 performing a specified interactive activity with the first virtual object 4111. The terminal device 410 displays an interaction process between the first virtual object 4111 and the second virtual object 4112 in response to an interactive operation for the first virtual object 4111 and the second virtual object 4112. The terminal device 410 generates an interaction result trigger instruction according to an interaction result between the first virtual object 4111 and the second virtual object 4112, and sends the interaction result trigger instruction to the server 420.

After receiving the interaction result trigger instruction from the terminal device 410, the server 420 determines text content of a special effect text element 4121 corresponding to the interaction result according to the interaction result trigger instruction, and feeds back element rendering data corresponding to the special effect text element 4121 to the terminal device 410. The element rendering data includes rendering sub-data of the special effect text element 4121 and animation sub-data corresponding to a conversion and drop animation corresponding to the special effect text element 4121.

After receiving the element rendering data, the terminal device 410 displays the corresponding special effect text element 4121 according to the rendering sub-data of the special effect text element 4121, and displays the conversion and drop animation corresponding to the special effect text element 4121 according to the animation sub-data. The conversion and drop animation is implemented as that the special effect text element 4121 is converted into a specified item and the specified item drops into the virtual scene 4110.

In response to a pick-up operation of the first virtual object 4111 for the specified item, the terminal device 410 displays an animation process in which the first virtual object 4111 picks up the specified item 4122.

The server 420 may be configured to provide a backend service to a client of the target application (for example, a game application) in the terminal device 410. For example, the server 420 may be a backend server of the target application (for example, the game application). The server 420 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

In some embodiments, the server 420 may alternatively be implemented as a node in a blockchain system.

In this embodiment of this application, before and during collection of related data of a user, a prompt interface or a pop-up window may be displayed or voice prompt information may be outputted. The prompt interface, the pop-up window, or the voice prompt information is configured for prompting the user that the related data of the user is currently being collected, so that in this application, after a confirmation operation performed by the user on the prompt interface or the pop-up window is obtained, related operations of obtaining the related data of the user is started. Otherwise (that is, when the confirmation operation performed by the user on the prompt interface or the pop-up window is not obtained), the related operations of obtaining the related data of the user ends, that is, the related data of the user is not obtained. In other words, processing of all user data collected in this application is strictly according to requirements of laws and regulations of relevant countries. Obtaining informed consent or individual consent of a personal information subject is collected under consent and authorization of the user. In addition, within the laws and regulations and authorization of the personal information subject, subsequent data use and processing behaviors are performed, and collection, use, and processing of related user data need to comply with relevant laws, regulations, and standards of relevant countries and regions. For example, the virtual scene, the interactive operation, the pick-up operation, and the like in this application are all obtained under full authorization.

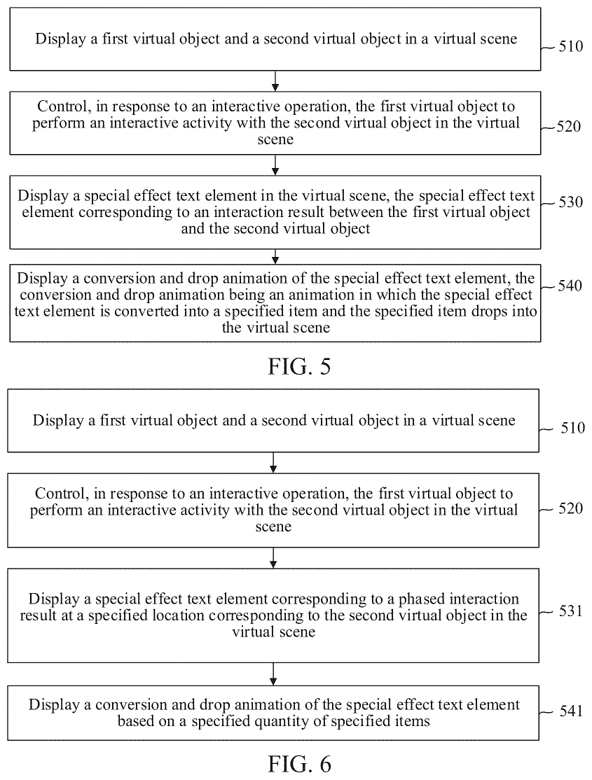

FIG. 5 is a flowchart of a virtual object interaction method according to an embodiment of this application. In this embodiment of this application, an example in which the method is applied to the terminal device 410 shown in FIG. 4 is used for description. The method includes the following operations.
Step 510: Display a first virtual object and a second virtual object in a virtual scene.

The virtual scene is a scene displayed (or provided) when a client of an application (for example, a game application) is run on a terminal device. The virtual scene is a scene created for a virtual object to perform activities (for example, a game battle). The virtual scene may be, for example, a virtual house, a virtual island, a virtual sky, or a virtual land. The virtual scene may be a simulated scene of the real world, may be a semi-simulated semi-fictional scene, or may be an entirely fictional scene. This is not limited in this embodiment of this application.

The virtual object may be a virtual object controlled by a user account in an application (for example, a game application). The game application is used as an example. The virtual object may be a virtual character controlled by the user account in the game application. For example, the first virtual object may be a virtual character controlled by a user account currently logged in to the client. The second virtual object may be controlled by the client or by another user account. This is not limited in this embodiment of this application.

For example, the client displays the virtual scene in a user interface. The virtual scene includes the first virtual object. The first virtual object may perform a virtual activity in the virtual scene. The virtual activity may include at least one of activities such as walking, running, jumping, climbing, casting a skill, picking up an item, and throwing an item.

In some embodiments, the virtual scene may further include the second virtual object. There is an opponent relationship between the second virtual object and the first virtual object, there is a teammate relationship between the second virtual object and the first virtual object, or there is no relationship between the second virtual object and the first virtual object. This is not limited in this embodiment of this application.

In some embodiments, the first virtual object or the second virtual object may be implemented as a virtual person, a virtual thing, a virtual animal, a virtual building, or the like. This is not limited in this embodiment of this application.
Step 520: Control, in response to an interactive operation, the first virtual object to perform an interactive activity with the second virtual object in the virtual scene.

The interactive operation may be an operation of enabling interaction between virtual objects. The operation may be implemented by a user through the terminal device. In this embodiment of this application, the interactive operation may be an interactive operation performed by a user of a current terminal device on the first virtual object. After receiving the interactive operation, a client may control, according to the interactive operation, the first virtual object to perform the interactive activity with the second virtual object in the virtual scene.

In some embodiments, the client obtains the interactive operation according to an interactive operation instruction triggered by the user. For example, the user may generate the interactive operation instruction for a virtual object by touching a display screen, or the user may generate the interactive operation instruction for a virtual object by operating a control device (for example, a keyboard, a mouse, or a gamepad). This is not limited in this embodiment of this application. For example, when there are the first virtual object and the second virtual object, the interactive operation instruction may include an interactive operation instruction triggered by a first user for the first virtual object and an interactive operation instruction triggered by a second user for the second virtual object, to implement interaction between the first virtual object and the second virtual object.

The interactive activity may be an activity that requires interaction between virtual objects. For example, the interactive activity may be implemented as that the first virtual object and the second virtual object perform a virtual battle (for example, a game battle), the first virtual object and the second virtual object jointly complete a specified task, or the like. This is not limited in this embodiment of this application. The virtual battle may be a battle in which virtual objects compete.

In some embodiments, when the interactive activity is implemented as that the first virtual object and the second virtual object perform the virtual battle, the interactive operation may be implemented as that the first virtual object casts a skill to the second virtual object, or attacks the second virtual object by using a virtual item.

When the interactive activity is implemented as that the first virtual object and the second virtual object jointly complete the specified task, the interactive operation may be implemented as that the first virtual object sends a task invitation to the second virtual object, so that the first virtual object and the second virtual object jointly perform the specified task.

In some embodiments, activity content of the interactive activity is preset; or the user may freely set specific activity content of the interactive activity. This is not limited in this embodiment of this application.
Step 530: Display a special effect text element in the virtual scene, the special effect text element corresponding to an interaction result between the first virtual object and the second virtual object.

The interaction result is a result of the interactive activity. For example, in the virtual battle, the first virtual object successively hits the second virtual object for a plurality of times. In some embodiments, the interaction result may be obtained by the client in real time. In other words, the special effect text element corresponding to the interaction result is also updated and displayed in real time.

The special effect text element is a view element obtained by applying a special effect to a text element, for example, a text filling special effect (for example, solid color filling or gradient filling), a text stroking special effect (for example, text superimposition or a neon special effect), a text gradual fading special effect, or a dynamic text special effect. In other words, a display manner of the special effect text element may be determined according to the applied special effect. The special effect text element is configured for describing the interaction result between the first virtual object and the second virtual object. For example, the interaction result may be configured for determining at least one of display content, a display manner, a display quantity, a display location, display duration, or the like corresponding to the special effect text element.

The display content is text content of the special effect text element. For example, the text content of the special effect text element may be determined according to text content of the current interaction result. The display manner is an element display manner corresponding to the special effect text element, for example, highlighting or flashing. The display quantity is a quantity of special effect text element. For example, one special effect text element is displayed once according to the interaction result. The display location is a location of the special effect text element when the special effect text element is displayed in the virtual scene, for example, a specified location (for example, above a head) corresponding to the first virtual object, or a specified location (for example, above a head) corresponding to the second virtual object. The display duration is display time of the special effect text element. For example, display duration of a single special effect text element in the virtual scene is 3 s.

In some embodiments, the interaction result between the first virtual object and the second virtual object corresponds to a single fixed special effect text element; or the interaction result may correspond to a plurality of different special effect text elements. This is not limited in this embodiment of this application.

In some embodiments, the special effect text element may be implemented as fixed display, that is, a same special effect text element is displayed each time; or display of the special effect text element corresponds to the interaction result, that is, different interaction results correspond to different special effect text elements.
Step 540: Display a conversion and drop animation of the special effect text element, the conversion and drop animation being an animation in which the special effect text element is converted into a specified item and the specified item drops into the virtual scene.

In some embodiments, the client generates the conversion and drop animation based on the special effect text element, and displays the conversion and drop animation in the user interface. In some embodiments, when the special effect text element changes, the special effect text element may be converted into the conversion and drop animation to start displaying.

For example, the conversion and drop animation may be configured for describing a conversion process between the special effect text element and the specified item and a process in which the specified item drops into the virtual scene. That is, in the current virtual scene, a generation manner of the specified item depends on the special effect text element. The specified item may be any virtual item, for example, an attack virtual item, a defense virtual item, an energy value obtaining item, a skill virtual item, or a buff virtual item (for example, restoring a health value). This is not limited in this embodiment of this application.

In an example, the conversion and drop animation may include at least one of the following animation display manners.
1: When the text content of the special effect text element is completely displayed, the client starts displaying an animation in which the special effect text element is converted into the specified item and the specified item drops into the virtual scene.
2: A duration threshold is preset, and when display duration of the special effect text element reaches the duration threshold, the client starts displaying an animation in which the special effect text element is converted into the specified item and the specified item drops into the virtual scene.
3: When receiving a conversion trigger operation for the special effect text element, the client displays the conversion and drop animation of the special effect text clement. The conversion trigger operation is configured for triggering display of the conversion and drop animation of the special effect text element. For example, when receiving the conversion trigger operation for the special effect text element, the client starts generating the corresponding conversion and drop animation based on the special effect text element, and displays the conversion and drop animation.

In some embodiments, converting the special effect text element into the specified item may refer to directly replacing the special effect text element with the specified item, may refer to canceling display of the special effect text element and additionally displaying the specified item at a set location, for example, a top of the virtual scene or a middle location of the virtual scene, or may refer to canceling display of the special effect text element and displaying an animation in which the specified item enters the virtual scene, for example, the virtual scene cracks and the specified item enters the virtual scene from the crack. This is not limited in this embodiment of this application.

The animation display manners of the conversion and drop animation are merely an exemplary example. This is not limited in this embodiment of this application.

In an example, a conversion manner of the specified item may include at least one of the following representation forms:
1: The client determines a specified quantity of specified items according to the special effect text element, that is, different special effect text elements are correspondingly converted into different quantities of specified items.
2: The client determines a specified item of a specified type according to the special effect text element, that is, different special effect text elements are correspondingly converted into specified items of different types.
3: The client determines a conversion effect of the specified item according to the special effect text element, that is, different special effect text elements correspond to different conversion forms. For example, a special effect text element A is sequentially converted into a corresponding specified item in a word-by-word manner, and the specified item drops into the virtual scene. This is used as the conversion and drop animation.

The item representation forms of the specified item are merely an exemplary example. This is not limited in this embodiment of this application.

In some embodiments, a process of converting the special effect text element into the specified item may be implemented as follows: The special effect text element is correspondingly converted into a specified quantity of specified items in sequence, and the specified items are displayed one by one and drop into the virtual scene in sequence. That is, a conversion process of the specified item is that the specified items are converted and displayed one by one. Alternatively, the client simultaneously converts the special effect text element into a preset quantity of specified items, and causes the preset quantity of specified items to simultaneously drop into the virtual scene. That is, a process of converting the special effect text element into the specified item is completed once, and the preset quantity of specified items are simultaneously displayed. This is not limited in this embodiment of this application.

In an example, a drop manner in which the specified item drops into the virtual scene may include at least one of the following manners:
1: After being generated, the specified item drops into the virtual scene in a free fall manner.
2: After being generated, the specified item drops into the virtual scene radially around the virtual scene by using a location at which the special effect text element generates the converted item as a start point.
3: A fixed drop location is preset for the specified item, and after being generated, the specified item drops toward the fixed drop location and finally drops at the fixed drop location.

The drop manners of the specified item are merely an exemplary example. This is not limited in this embodiment of this application.

In some embodiments, when the conversion and drop animation is implemented as generating a plurality of specified items, the plurality of specified items drop at a same fixed location in the virtual scene, or the plurality of specified items drop at different locations in the virtual scene. This is not limited in this embodiment of this application.

In an example, after the specified item drops into the virtual scene, a user may control a virtual object to pick up the specified item. For example, the client controls, in response to a pick-up operation for the specified item, the first virtual object to pick up the specified item in the virtual scene.

In some embodiments, when the first virtual object actively completes interaction with the second virtual object (for example, when the first virtual object hits the second virtual object), the specified item generates a specified buff effect on the first virtual object, and the first virtual object may obtain the corresponding specified buff effect by picking up the specified item. In this way, interaction between the virtual objects can be triggered, thereby improving interaction between the virtual objects. The specified buff effect may be set and adjusted according to an actual use requirement, for example, a health value is restored, an energy value increases, or attack damage increases. This is not limited in this embodiment of this application.

For example, the specified item may be implemented as a usable item. After picking up the specified item, the first virtual object may use the specified item to perform the interactive activity with the second virtual object. In some embodiments, the specified item may alternatively be implemented as a special effect item. After the first virtual object picks up the specified item, the client displays a special effect corresponding to the specified item.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In some embodiments, when the interaction result of the interactive activity is implemented as corresponding to a plurality of different special effect text elements, the interactive activity may include a plurality of activity phases. Each activity phase corresponds to a phased interaction result, and a single phased interaction result corresponds to a single special effect text element. For example, FIG. 6 is a flowchart of a virtual object interaction method according to another exemplary embodiment of this application. To be specific, in the foregoing embodiments, step 540 further includes step 541, and step 530 further includes step 531. As shown in FIG. 6, the method includes the following operations.
Step 510: Display a first virtual object and a second virtual object in a virtual scene.

The first virtual object is a virtual object mainly controlled by the current terminal device. In some embodiments, there is an opponent relationship between the first virtual object and the second virtual object; or there is a teammate relationship between the first virtual object and the second virtual object.

In some embodiments, the first virtual object and the second virtual object are virtual objects of a same type. For example, both the first virtual object and the second virtual object are virtual persons. Alternatively, the first virtual object and the second virtual object are virtual objects of different types. For example, the first virtual object is implemented as a virtual person, and the second virtual object is implemented as a virtual beast or a virtual thing. This is not limited in this embodiment of this application.
Step 520: Control, in response to an interactive operation, the first virtual object to perform an interactive activity with the second virtual object in the virtual scene.

In some embodiments, an operation manner of the interactive operation may include at least one of the following operation manners:
1: The interactive operation is implemented as that the current terminal device controls the first virtual object to perform an activity in the virtual scene.

When the interactive activity is implemented as that the first virtual object and the second virtual object perform the virtual battle, the interactive operation may be implemented as that the client controls, in response to an attack trigger operation for the first virtual object, the first virtual object to perform an attack operation like fighting or casting a skill on the second virtual object. Alternatively, when the interactive activity is implemented as that the first virtual object and the second virtual object jointly complete the specified task, the interactive operation may be implemented as that the first virtual object sends a task invitation to the second virtual object.
2: An interactive activity list is displayed in the user interface, and the interactive operation is implemented as that a specified interactive activity is selected from the interactive activity list, and the client displays an animation in which the first virtual object and the second virtual object perform the specified interactive activity.

The operation manners of the current interactive operation are merely an exemplary example. This is not limited in this embodiment of this application.
Step 531: Display a special effect text element corresponding to a phased interaction result at a specified location corresponding to the second virtual object in the virtual scene.

Text content of the special effect text element corresponding to the phased interaction result corresponds to the phased interaction result. The phased interaction result is an interaction result in an activity phase, for example, an interaction result in a current activity phase. In some embodiments, the special effect text element corresponding to the phased interaction result may alternatively be displayed at a specified location corresponding to the first virtual object in the virtual scene. In this way, eyes of the user can be always concentrated on the virtual object, which is more convenient to improve the focus of the user on the interactive activity, so that interaction experience of the user is improved.

For example, the interactive activity includes a plurality of activity phases, and an interaction result of each activity phase is used as a phased interaction result. In other words, the phased interaction result is configured for indicating an interaction result corresponding to a current activity phase when the first virtual object and the second virtual object perform the interactive activity. For example, when the interactive activity is implemented as that the first virtual object and the second virtual object perform the virtual battle in a current round, a process in which each time the first virtual object attacks the second virtual object corresponds to one activity phase. Therefore, a single hit result of the second virtual object in the current round is a phased interaction result.

In some examples, different phased interaction results correspond to text content of different special effect text elements.

For example, when an (m+1)^{th} phased interaction result is generated in a process of displaying a special effect text element corresponding to an m^{th} phased interaction result, the display of the special effect text element corresponding to the m^{th} phased interaction result is canceled, and a special effect text element corresponding to the (m+1)^{th} phased interaction result is displayed. The two special effect text elements are sequentially displayed at a same location. A display manner of the special effect text element corresponding to the (m+1)^{th} phased interaction result includes at least one of display manners such as superimposition display and replacement display.

In some embodiments, when an (m+1)^{th} phased interaction result is generated in a process of displaying a special effect text element corresponding to an m^{th} phased interaction result, the display of the special effect text element corresponding to the m^{th} phased interaction result is canceled, and a special effect text element corresponding to the (m+1)^{th} phased interaction result is displayed. The two special effect text elements are displayed at different locations. m is a positive integer.

The display manner of the special effect text element is described below by using two different interactive activities as an example.

First, the interactive activity is implemented as a virtual battle.

In this embodiment of this application, when the first virtual object and the second virtual object perform the virtual battle, the client receives an interactive operation and controls, according to the interactive operation, the first virtual object to cast a skill to the second virtual object for attack. In a current round, if the skill cast by the first virtual object hits the second virtual object, the client displays, according to a hit result, a special effect text clement corresponding to the hit result.

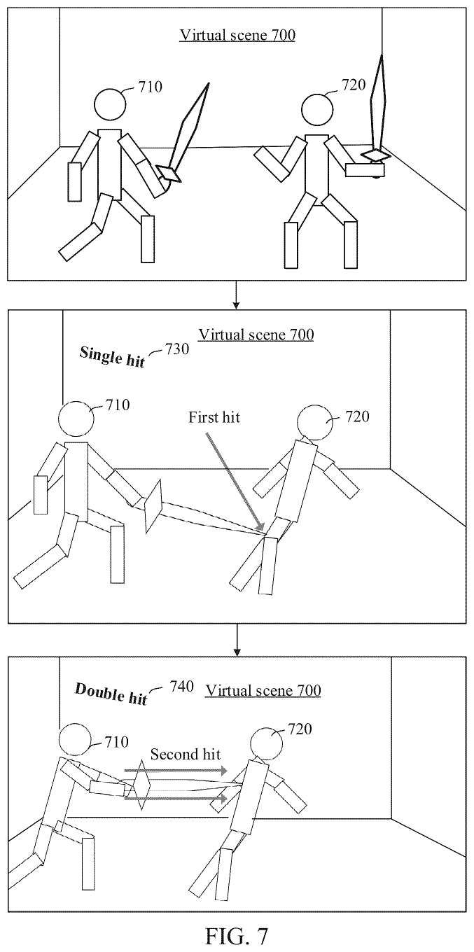

For example, FIG. 7 is a schematic diagram of a special effect text element content display method according to an exemplary embodiment of this application. As shown in FIG. 7, a user interface displays a virtual scene 700. In a current round, in a process in which a first virtual object 710 casts a skill to a second virtual object 720, if the second virtual object 720 is hit for the first time, a special effect text element 730 “single hit” is displayed above the first virtual object 710, to indicate that a first skill hit of the first virtual object 710 is implemented in the current round.

In an implementable case, if the first virtual object 710 casts a skill to the second virtual object 720 again after hitting the second virtual object 720 for the first time in the current round, and the skill also hits the second virtual object 720, that is, if the first virtual object 710 successively hits the second virtual object 720 twice by casting the skills in the current round, the current special effect text element 730 “single hit” is replaced with a special effect text element 740 “double hit”. In this embodiment of this application, text content of special effect text elements corresponding to different phased interaction results is different. In this way, interaction display manners can be enriched, so that the user has an accomplishment sense of successful attack, and user interaction experience is improved.

In another implementable case, in the current round, the first virtual object 710 casts two skills to the second virtual object 720 again in sequence after hitting the second virtual object 720 for the first time. If in the two cast skills, the second skill hits the second virtual object 720 again, that is, if the first virtual object 710 hits the second virtual object 720 by using the two skills (but does not successively hit the second virtual object 720) in the current round, when the second skill is cast and hits the second virtual object 720, the current special effect text element 730 “single hit” is replaced with a special effect text element 740 “double hit” for display.

The two implementable cases are two parallel cases, and any case may be selected for displaying the special effect text element. This is not limited.

Second, the interactive activity is implemented as jointly completing the specified task.

In this embodiment of this application, the specified task includes a plurality of phased tasks, and the first virtual object and the second virtual object are implemented as a teammate relationship. In a process in which the first virtual object and the second virtual object jointly complete the specified task, when a first phased task is completed, the client displays a special effect text element corresponding to the first phased task, and when a second phased task is completed, the client displays a special effect text element corresponding to the second phased task. That is, the special effect text element is configured for indicating a completion status of a current phased task.

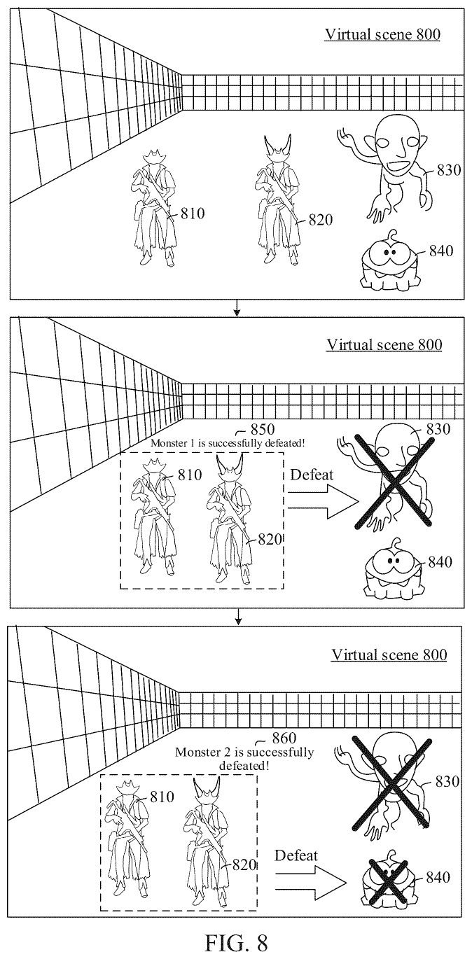

An example in which the virtual scene is a game challenging scene is used. The specified task is that the first virtual object and the second virtual object jointly defeat a plurality of different virtual monsters. For example, FIG. 8 is a schematic diagram of a special effect text element content display method according to an exemplary embodiment of this application. As shown in FIG. 8, a current virtual scene 800 includes a first virtual object 810 and a second virtual object 820. A specified task is implemented as that the first virtual object 810 and the second virtual object 820 jointly attack a first object 830 and a second object 840. When any one of the first virtual object 810 and the second virtual object 820 defeats the first object 830, a special effect text element 850 “Monster 1 is successfully defeated!” is displayed above the first virtual object 810 or the second virtual object 820, to indicate that a phased task in which the first virtual object 810 and the second virtual object 820 defeat the first object 830 is completed. When any one of the first virtual object 810 and the second virtual object 820 defeats the second object 840, a special effect text element 860 “Monster 2 is successfully defeated!” is displayed above the first virtual object 810 or the second virtual object 820, to indicate that a phased task in which the first virtual object 810 and the second virtual object 820 defeat the second object 840 is completed. Text content of the special effect text element corresponds to a defeated object. For example, the text content of the special effect text element is constructed based on a name of the defeated object.
Step 541: Display the conversion and drop animation of the special effect text clement based on a specified quantity of specified items.

The conversion and drop animation is an animation in which the special effect text element is converted into the specified quantity of specified items and the specified items drop into the virtual scene. The specified quantity corresponds to text content of the special effect text element. The specified quantity is a quantity of specified items when the special effect text element is converted into the specified item.

In some embodiments, the specified quantity of specified items corresponds to the text content of the special effect text element, and the text content of the special effect text element corresponds to a phased interaction result. That is, the specified quantity corresponds to obtaining of the phased interaction result. Different phased interaction results correspond to special effect text elements with different text content. Therefore, specified quantities of specified items converted from each special effect text element are also different. In this way, display manners of the conversion and drop animation can be enriched, and an interest of the user in obtaining different conversion and drop animations is stimulated, thereby helping improve user viscosity.

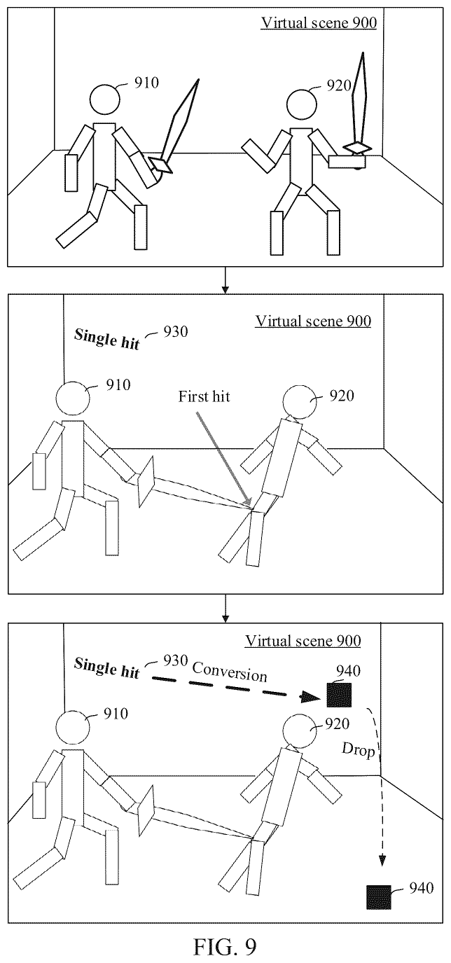

For example, in a game battle, the specified quantity is positively correlated with a quantity of successive hits. For example, FIG. 9 is a schematic diagram of a specified item generation process according to an exemplary embodiment of this application. As shown in FIG. 9, a user interface displays a virtual scene 900. In a process in which a first virtual object 910 attacks a second virtual object 920 in a current round, when the second virtual object 920 is hit for the first time, a client displays a special effect text element 930 “single hit”. A first hit result is used as a phased interaction result of the current round, and the first hit result is implemented as that the special effect text element 930 “single hit” is converted into one specified item 940, that is, the client displays a conversion and drop animation in which the special effect text element 930 “single hit” is converted into the specified item 940 and the specified item 940 drops into the virtual scene.

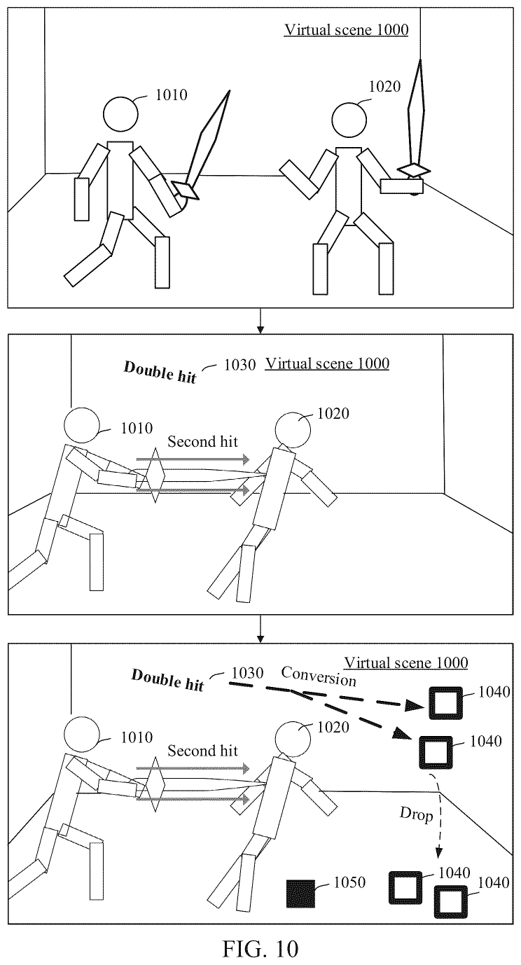

FIG. 10 is a schematic diagram of a specified item generation process according to another exemplary embodiment of this application. As shown in FIG. 10, a user interface displays a virtual scene 1000. In a process in which a first virtual object 1010 attacks a second virtual object 1020 in a current round, when the second virtual object 1020 is successively hit twice (a first hit process is not displayed in FIG. 10, and for the first hit process, reference may be made to FIG. 9), the client displays a special effect text element 1030 “double hit”. A result of two successive hits is used as a phased interaction result of the current round. A second hit result is implemented as that the special effect text element 1030 “double hit” is converted into two specified items 1040, that is, the client displays a conversion and drop animation in which the special effect text element 1030 “double hit” is converted into the two specified items 1040, and the specified items 1040 drop into the virtual scene. In addition, FIG. 10 further includes: After the first virtual object 1010 hits the second virtual object 1020 for the first time, the displayed special effect text element “single hit” is converted into one specified item 1050, and the specified item 1050 drops.

In this embodiment of this application, each time a special effect text element is displayed, a conversion and drop animation corresponding to the special effect text element is displayed, and a specified quantity of specified items drop into the virtual environment. When the client displays a special effect text element according to a k^{th} phased interaction result, display of a specified item corresponding to a (k−1)^{th} phased interaction result is maintained or canceled. Alternatively, when the client displays a special effect text element according to a k^{th} phased interaction result, a special effect text element corresponding to a (k−1)^{th} phased interaction result is converted into a specified item. This is not limited in this embodiment of this application. k is a positive integer.

In some embodiments, the conversion and drop animation of the special effect text element is an animation in which a two-dimensional special effect text element is converted into a two-dimensional specified item and the specified item drops. Alternatively, the conversion and drop animation of the special effect text element is an animation in which a two-dimensional special effect text element is converted into a three-dimensional specified item and the specified item drops.

In an example, when the conversion and drop animation is implemented as that the two-dimensional special effect text element is converted into the specified item, the method may include the following content: displaying, by the client, a shrinking and disappearing animation of the special effect text element, the shrinking and disappearing animation being an animation in which display of the special effect text element is canceled after the special effect text element shrinks at the specified location corresponding to the second virtual object; obtaining first coordinates of the specified location in a world coordinate system of the virtual scene as start coordinates of the specified item; obtaining second coordinates corresponding to the first coordinates in the world coordinate system as landing coordinates of the specified item; obtaining drop path data of the specified item based on the first coordinates and the second coordinates; and displaying, according to the drop path data, the conversion and drop animation in which the specified item drops.

In this embodiment of this application, in a process of displaying the conversion and drop animation of the special effect text element, the shrinking and disappearing animation of the special effect text element is first displayed, and then the conversion and drop animation is displayed. When the special effect text element starts shrinking, the shrinking and disappearing animation starts to be displayed. The second coordinates are different from the first coordinates. The second coordinates may be coordinates located on a virtual ground in the virtual scene, for example, coordinates close to the first virtual object or the second virtual object.

In some embodiments, the first coordinates may be implemented as two-dimensional coordinates; or the first coordinates may be implemented as three-dimensional coordinates. This is not limited in this embodiment of this application. The first coordinates may be implemented as the start coordinates at which the specified item drops. That is, at the first coordinates, the special effect text element is converted into the specified item and the specified item starts dropping. The second coordinates are implemented as an end location at which the specified item drops.

For example, after obtaining the second coordinates corresponding to the first coordinates in the world coordinate system corresponding to the virtual scene, the client determines the second coordinates as landing coordinates at which the specified item finally drops into the virtual scene. The client obtains the drop path data corresponding to the specified item according to the first coordinates and the second coordinates, to describe a drop path in which the specified item drops into the virtual scene.

In an example, after obtaining the drop path data, the client may further determine a texture material set corresponding to the specified item. The texture material set includes texture materials corresponding to a plurality of specified items. The texture materials are configured for describing material images obtained by capturing the specified item by a camera from different angles.

The client may obtain, according to an observation perspective corresponding to the specified item in the drop path data, a texture material image corresponding to the observation perspective from the texture material set. The observation perspective refers to a first-person perspective or a third-person perspective corresponding to the current terminal device. Different texture material images of the specified item may be obtained according to different observation perspectives. For example, if the observation perspective is northwest 45 degrees, a texture material image of the specified item corresponding to northwest 45 degrees is obtained from the texture material set. The client displays the texture material image of the specified item along a drop trajectory corresponding to the drop path data. That is, the client obtains, based on the observation perspective of the specified item, the texture material image corresponding to the observation perspective from the texture material set, and displays the texture material image along the drop trajectory corresponding to the drop path data as the conversion and drop animation in which the specified item drops.

In an example, after the specified item drops into the virtual scene, a user may control a virtual object to pick up the specified item. For example, the client controls, in response to a pick-up operation for the specified item, the first virtual object to pick up the specified item in the virtual scene.

In some embodiments, an operation manner of the pick-up operation may include at least one of the following manners:
1: The pick-up operation may be implemented as controlling the first virtual object to pick up at least one specified item in the virtual scene.
2: The pick-up operation may be implemented as performing a trigger operation on the specified item dropping into the virtual scene and displaying that the first virtual object automatically picks up the triggered specified item, and the trigger operation is used as the pick-up operation.

The operation manners of the pick-up operation are merely an exemplary example. This is not limited in this embodiment of this application.

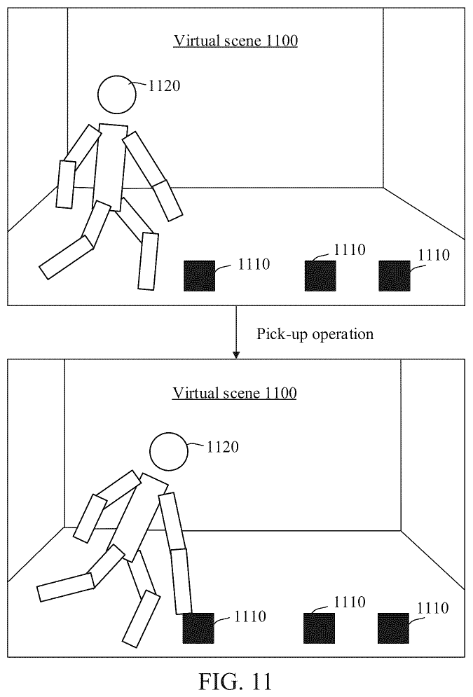

For example, FIG. 11 is a schematic diagram of a specified item pick-up process according to an exemplary embodiment of this application. As shown in FIG. 11, a user interface displays a virtual scene 1100. The virtual scene 1100 includes a plurality of specified items 1110 corresponding to a conversion and drop animation. A client controls, in response to a pick-up operation for the specified item 1110, a first virtual object 1120 to pick up one of the specified items 1110.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In this embodiment of this application, the special effect text element is converted into a specified quantity of specified items, and the specified quantity corresponds to text content of the special effect text element, so that the user can sense the quantity of specified items after obtaining the interaction result. This helps improve an accomplishment sense and experience of the user.

In this embodiment of this application, when an interactive task includes a plurality of activity phases, a corresponding special effect text element is displayed according to a phased interaction result corresponding to each activity phase. Text content of the special effect text element corresponds to the phased interaction result, so that the user can improve enthusiasm in participating in the interactive activity.

In this embodiment of this application, the phased interaction result corresponds to the specified quantity of specified items, so that an interaction manner in which an increase in the specified quantity is related to the phased interaction result is implemented, thereby enriching the diversity of interaction manners between the virtual objects.

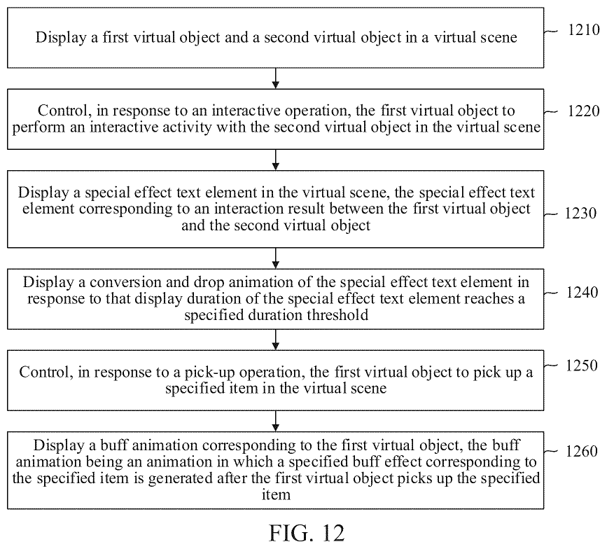

In some embodiments, after the first virtual object picks up the specified item, the client displays a buff animation corresponding to the first virtual object, that is, the specified item generates a specified buff effect on the first virtual object. For example, FIG. 12 is a flowchart of a virtual object interaction method according to another exemplary embodiment of this application. As shown in FIG. 12, the method may include the following operations.
Step 1210: Display a first virtual object and a second virtual object in a virtual scene.
Step 1220: Control, in response to an interactive operation, the first virtual object to perform an interactive activity with the second virtual object in the virtual scene.

Step 1210 is the same as the descriptions of step 510, and step 1220 is the same as the descriptions of step 520. For content not described in this embodiment of this application, reference may be made to the foregoing embodiments. Details are not described herein again.
Step 1230: Display a special effect text element in the virtual scene, the special effect text element corresponding to an interaction result between the first virtual object and the second virtual object.

In some embodiments, the interactive activity includes a plurality of activity phases, an i^{th} activity phase corresponds to an i^{th} special effect text element, and i is a positive integer.

For example, the interactive activity includes a plurality of different activity phases, and there is a progressive relationship between the activity phases. If the interactive activity is implemented as that the first virtual object and the second virtual object perform a virtual battle of a single round, the plurality of activity phases correspond to a quantity of times that the second virtual object is hit in a process in which the first virtual object attacks the second virtual object. For example, in a current round, when the second virtual object is hit for the first time, an interaction process in which the first virtual object and the second virtual object start performing the virtual battle in the current round and the second virtual object is hit for the first time is used as a first activity phase. When the second virtual object is hit for the second time, an interaction process in which the second virtual object is hit for the first time and the second virtual object is hit for the second time is used as a second activity phase. Therefore, there is a relationship in which a quantity of hits is progressive between the second activity phase and the first activity phase.

In this embodiment of this application, each activity phase corresponds to a phased interaction result. For example, a first phased interaction result corresponding to the first activity phase is “the second virtual object is hit for the first time”, and a second phased interaction result corresponding to the second activity phase is “the second virtual object is hit for the second time”.

In this embodiment of this application, the client may display a special effect text element according to a phased interaction result. Text content of the special effect text element corresponds to the phased interaction result. For example, a displayed special effect text element corresponding to the first phased interaction result is implemented as “single hit” (namely, one successive hit). A displayed special effect text element corresponding to the second phased interaction result is implemented as “double hit” (namely, two successive hits). The text content of the special effect text element is configured for describing the corresponding phased interaction result.
Step 1240: Display the conversion and drop animation of the special effect text element in response to that display duration of the special effect text element reaches a specified duration threshold.

The display duration of the special effect text element is a display time length of the special effect text element in the virtual scene.

In some embodiments, the specified duration threshold may be a preset fixed value; or the user may freely adjust the specified duration threshold. This is not limited in this embodiment of this application.

In some embodiments, the display manner of the conversion and drop animation includes at least one of the following manners.
1: The interactive activity includes a plurality of activity phases. Each activity phase corresponds to a single special effect text element, and each special effect text element is independently displayed. For example, in a process of displaying a first special effect text clement corresponding to a first activity phase (a specified duration threshold is not reached), in response to that a second activity phase ends, the client displays a second special effect text element according to a phased interaction result corresponding to the second activity phase. In this case, the first special effect text element and the second special effect text clement are each independently displayed in a virtual environment, and display duration of the first special effect text element is not affected after the second special effect text element is displayed. When the display duration of the first special effect text element reaches the specified duration threshold corresponding to the first special effect text element, the client displays a conversion and drop animation of the first special effect text element. A display manner of a conversion and drop animation corresponding to the second special effect text clement is the same as that of the conversion and drop animation of the first special effect text element. Therefore, there are a dropping specified item converted from the first special effect text element and a dropping specified item converted from the second special effect text element in the current virtual environment.
2: The interactive activity includes a plurality of activity phases. Each activity phase corresponds to a single special effect text element, and each special effect text element is implemented as replacement display. For example, in a process of displaying a first special effect text element corresponding to a first activity phase (a specified duration threshold is not reached), in response to that a phased activity result is generated in a second activity phase, the client replaces the first special effect text element with a second special effect text clement corresponding to the second activity phase and displays the second special effect text element, and cancels the display of the first special effect text element.

When display duration of the second special effect text element reaches the specified duration threshold and a phased interaction result corresponding to a third activity phase is not received, the client displays a conversion and drop animation of the second special effect text element. Therefore, there is only a dropping specified item converted from the second special effect text element in the virtual environment. In other words, in response to that display duration of the i^{th} special effect text element reaches the specified duration threshold and a phased interaction result of an (i+1)^{th} activity phase is not received within a range of the specified duration threshold, the client displays a conversion and drop animation of the i^{th} special effect text element. According to the progressive relationship between the activity phases, a corresponding conversion and drop animation is sequentially updated and displayed, which helps to stimulate the user to trigger different activity phases, thereby improving the user viscosity.

In some embodiments, in the second display manner, the specified duration threshold is for a single special effect text element. To be specific, when the first special effect text element is replaced with the second special effect text element for display, calculation of current display duration of the second special effect text element is restarted. Alternatively, the specified duration threshold is for the entire interactive activity. The display duration is calculated from start of display of the first special effect text element. If the second special effect text element replaces the first special effect text element and is displayed, and no third special effect text element replaces the second special effect text clement and is displayed, the specified duration threshold is a sum of the display duration of the first special effect text element and the display duration of the second special effect text clement. This not limited in this embodiment of this application.

The display manners of the conversion and drop animation are merely an exemplary example. This is not limited in this embodiment of this application.

In some embodiments, specified items converted from the special effect text elements corresponding to the activity phases are items of a same type; or specified items converted from the special effect text elements corresponding to the activity phases are items of different types. This is not limited in this embodiment of this application.
Step 1250: Control, in response to a pick-up operation, the first virtual object to pick up the specified item in the virtual scene.

Step 1250 is the same as the descriptions of the foregoing embodiments. Details are not described herein again.
Step 1260: Display a buff animation corresponding to the first virtual object, the buff animation is an animation in which a specified buff effect corresponding to the specified item is generated after the first virtual object picks up the specified item.

The specified buff effect is related to a quantity of specified items picked up by the first virtual object or the specified buff effect is related to a type of the specified item picked up by the first virtual object.

For example, when starting displaying the specified buff effect for the first virtual object, the client starts displaying the corresponding buff animation.

In some embodiments, the specified buff effect may be configured for increasing an attribute effect of the first virtual object. The attribute effect includes at least one of a health value, an energy value, a mana value, a defense value, an attack capability, a role level, or the like of the first virtual object. After picking up the specified item, the first virtual object may use the specified item. For example, after the first virtual object picks up the specified item, the specified item is converted into an interactive item for the first virtual object to use.

In some examples, an effect duration threshold is preset for the specified buff effect. When the specified buff effect reaches the effect duration threshold, the specified buff effect disappears. Alternatively, the specified buff effect is implemented as a persistent buff effect, that is, the specified buff effect does not automatically disappear. This is not limited in this embodiment of this application.

In some embodiments, the pick-up operation is configured for allowing the first virtual object to pick up one specified item once; or the pick-up operation is configured for allowing the first virtual object to pick up a plurality of specified items once. In some embodiments, a display duration threshold is preset for the specified item in the virtual scene. When display duration of the specified item in the virtual scene reaches the display duration threshold, display of the specified item is automatically canceled, so that the first virtual object cannot pick up the specified item. Alternatively, an effect threshold is preset for the specified buff effect of the specified item in the virtual scene. When display duration of the specified item in the virtual scene reaches the effect threshold, display of the specified item is not canceled, but the specified item no longer has the specified buff effect, or an effect type of the specified buff effect changes. This is not limited in this embodiment of this application.

In some examples, a single specified item corresponds to a single specified buff effect. That is, after the first virtual object picks up the specified item, the corresponding specified buff effect is generated. Alternatively, a single specified item corresponds to a plurality of candidate buff effects. After the first virtual object picks up the specified item, at least one buff effect is selected from the plurality of candidate buff effects. Alternatively, after the first virtual object successively picks up at least two specified items, the two specified items generate a combined buff effect on the first virtual object. To be specific, the two specified items respectively have respective specified buff effects on the first virtual object, but after both the two specified items are picked up, the combined buff effect is generated, and the combined buff effect is different from the specified buff effects respectively corresponding to the two specified items. This is not limited in this embodiment of this application.

In some embodiments, the buff animation is related to the specified buff effect corresponding to the specified item picked up by the first virtual object. For example, each time the first virtual object picks up a specified item, the client displays a buff animation corresponding to the picked up specified item. Alternatively, after the first virtual object successively picks up a plurality of specified items, the client displays buff animations respectively corresponding to the plurality of specified items. This is not limited in this embodiment of this application.

In an example, a representation form in which the specified buff effect is related to a quantity of specified items includes at least one of the following forms.
1: If the virtual scene includes a plurality of specified items, and the plurality of specified items correspond to buff effects of a same type, a larger quantity of specified items picked up by the first virtual object indicates a better specified buff effect generated by the picked up specified items. For example, the virtual scene includes an item a (a buff effect is a health value plus 10), an item b (a buff effect is a health value plus 5), and an item c (a buff effect is a health value plus 15). If the first virtual object picks up the item a and the item b, a generated specified buff effect is a health value plus 15. If the first virtual object picks up the item a, the item b, and the item c, a generated specified buff effect is a health value plus 30.
2: A buff effect of the specified buff effect corresponds to a quantity of specified items. To be specific, if a quantity of specified items picked up by the first virtual object reaches a quantity threshold, a buff effect corresponding to the quantity threshold is generated on the first virtual object. For example, it is preset that picking up two specified items may increase a mana value by five points and picking up 15 specified items may increase the mana value by 15 points. When the virtual scene includes 20 specified items, when the first virtual object picks up three specified items, a specified buff effect of increasing the mana value by five points is generated on the first virtual object. When a quantity of specified items picked up by the first virtual object reaches 15, a specified buff effect of increasing the mana value by 15 points is generated to the first virtual object (the mana value is increased by additional 10 points based on the increased five points of the mana value).
3: Generation time of the specified buff effect is related to a quantity of picked up specified items. Respective corresponding buff effect generation time is preset according to different quantities of specified items. That is, a larger quantity of specified items successively picked up by the first virtual object indicates that a corresponding specified buff effect is generated at a faster speed. For example, when the first virtual object successively picks up three specified items, a health value is increased by 30 points within 0.5 s. When the first virtual object successively picks up five specified items, the health value is increased by 30 points within 0.2 s.

The representation forms in which the specified buff effect is related to the quantity are merely an exemplary example. This is not limited in this embodiment of this application.

In some examples, a representation form in which the specified buff effect is related to a type of the specified item includes at least one of the following forms.
1: If the virtual scene includes a plurality of specified items, and the plurality of specified items respectively correspond to buff effects of different types, the first virtual object picks up specified items of different types, to generate specified buff effects of different types. For example, the virtual scene includes an item A (a buff effect is a magic value plus 10) and an item B (a buff effect is a defense value plus 5). After the first virtual object picks up the item A, the magic value may be increased by 10 points, or after the first virtual object picks up the item B, the defense value may be increased by five points.
2: The virtual scene includes a plurality of specified items, and the plurality of specified items respectively correspond to buff effects of different types. However, a synthetic relationship is preset between at least two specified items. To be specific, after the first virtual object successively picks up the at least two specified items, a synthetic buff effect corresponding to the at least two specified items is generated. For example, the virtual scene includes an item 1 (a buff effect is a force value plus 10), an item 2 (a buff effect is a defense value plus 10), and an item 3 (a buff effect is a health value plus 10). After the first virtual object successively picks up the item 1, the item 2, and the item 3, a generated specified buff effect is that a role level of the first virtual object is increased by 1, but if the first virtual object picks up only the item 1, the generated specified buff effect is only the force value plus 10.

The representation forms in which the specified buff effect is related to the type are merely an exemplary example. This is not limited in this embodiment of this application.

In some embodiments, the following provides two different buff animation display manners.

First, the buff animation is implemented as highlighting a specified buff effect on a peripheral side range of the first virtual object.

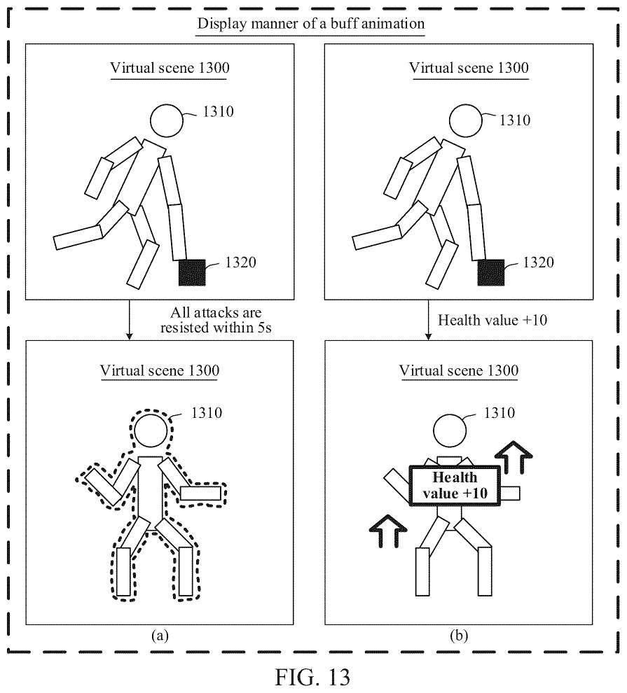

In this embodiment of this application, the specified buff effect corresponding to the specified item is implemented as increasing an attribute value (for example, at least one of a health value, a force value, or a defense value) of the first virtual object. After the first virtual object picks up the specified item, the specified buff effect is highlighted on the peripheral side range of the first virtual object, to indicate the specified buff effect currently generated by the first virtual object by picking up the specified item. This process is used as the buff animation. For example, FIG. 13 is a schematic diagram of a buff effect display manner according to an exemplary embodiment of this application. As shown in (a) in FIG. 13, a user interface currently displays a virtual scene 1300. If a first virtual object 1310 picks up a specified item 1320 in the virtual scene 1300, and a specified buff effect corresponding to the specified item 1320 is that all attacks are resisted within 5 s, the client displays a buff animation of the first virtual object 1310 in the virtual scene 1300. The buff animation is implemented as highlighting a defense effect on a peripheral side range of the first virtual object 1310 (the defense effect is represented by a dashed line in (a) in FIG. 13), and duration is 5 s.

Second, the buff animation is implemented as displaying text content of the specified buff effect at a set location of the first virtual object.

In this embodiment of this application, after the first virtual object picks up the specified item, and the specified buff effect corresponding to the specified item is implemented as increasing an attribute value of the first virtual object, the client displays text content corresponding to the increased attribute value at the set location of the first virtual object as the buff animation. As shown in (b) in FIG. 13, the user interface currently displays the virtual scene 1300. If the first virtual object 1310 picks up the specified item 1320 in the virtual scene 1300, and a specified buff effect corresponding to the specified item 1320 is “a health value plus 10”, the client displays a buff animation of the first virtual object 1310 in the virtual scene 1300. The buff animation is implemented as displaying text content corresponding to the specified buff effect “the health value plus 10” in a center of a body of the first virtual object 1310.

In an example, the virtual scene further includes an attribute slot corresponding to the first virtual object. The attribute slot includes an attribute value, and the attribute value is configured for describing a status in which the first virtual object has an attribute. In this embodiment of this application, the attribute slot corresponding to the first virtual object is configured for indicating a real-time attribute value owned by the first virtual object when performing the interactive activity with the second virtual object. For example, the attribute slot of the first virtual object is a health value slot (a full value of the health value slot is 100 points). In this case, the attribute value is a real-time health value corresponding to the first virtual object in a current activity phase when the first virtual object interacts with the second virtual object (a current interactive activity is a virtual battle, and when the first virtual object is currently hit by a normal attack of the second virtual object once in a battle process, the real-time health value of the first virtual object is 90 points, where an attack result of being hit by the normal attack is that the health value is reduced by 10 points).

In some embodiments, the client further displays an attribute value-adding animation corresponding to the first virtual object. The attribute value-adding animation being an animation in which the attribute value increases to a target attribute value along with the buff animation, and an attribute value increment between the initial attribute value and the target attribute value is related to the specified buff effect. The attribute value-adding animation may also be displayed as part of the buff animation.

For example, the attribute value-adding animation is configured for describing a case in which after the first virtual object picks up the specified item, the attribute value increment of the specified buff effect corresponding to the specified item is generated. For example, the attribute slot of the first virtual object is implemented as a health value slot, and an initial attribute value of the first virtual object is 50 points (a full health value is 100 points). When the first virtual object picks up the specified item (the specified buff effect is a health value plus 20 points), the client further displays, in a process of displaying the buff animation of the first virtual object, an animation in which the health value in the health value slot of the first virtual object increases from 50 points to 70 points. A health value increment of 20 points is the specified buff effect corresponding to the specified item.

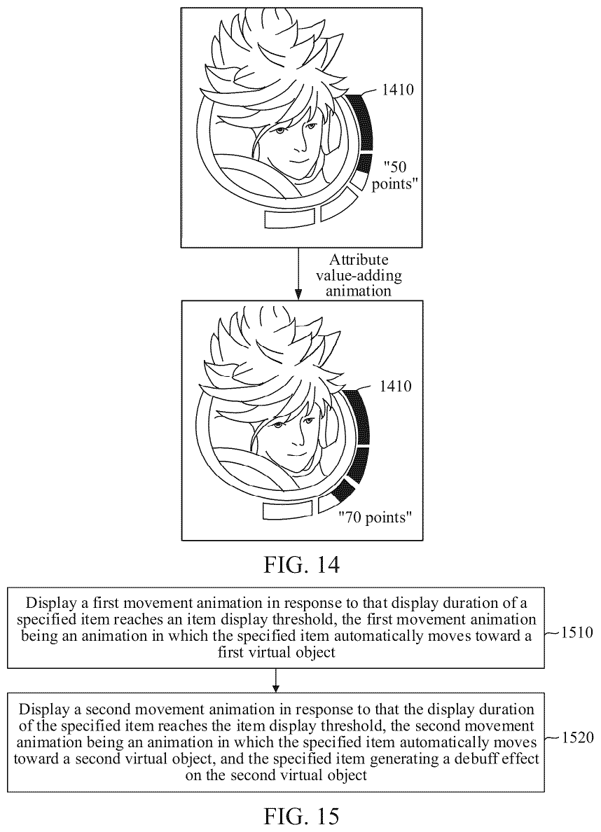

For example, FIG. 14 is a schematic diagram of an attribute value-adding animation according to an exemplary embodiment of this application. As shown in FIG. 14, a user interface displays an attribute slot 1410 corresponding to a first virtual object. The attribute slot 1410 is implemented as a health value slot. The attribute slot 1410 has a corresponding health value of 50 points as an initial attribute value. When the first virtual object picks up a specified item, and a specified buff effect of the specified item is “a health value plus 20 points”, the client displays an attribute value-adding animation of the attribute slot 1410 in a process of displaying a buff animation of the first virtual object (not shown in FIG. 14). The attribute value-adding animation is represented as that the initial health value of “50 points” in the attribute slot 1410 increases to a target health value of “70 points”.

In a feasible example, the attribute value in the attribute slot is configured for indicating an energy value obtained by the first virtual object through the specified item, and the energy value may be configured for obtaining a buff effect, for example, obtaining an additional skill, increasing an attack power, or increasing a defense power.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In this embodiment of this application, when the interactive activity is implemented as including a plurality of activity phases, and the special effect text element corresponds to the activity phase, a specified duration threshold is set for the display duration of the special effect text element, so that special effect text elements corresponding to different activity phases may be jointly displayed or displayed in a replaceable manner, thereby enriching diversity of display manners of the special effect text element.

In this embodiment of this application, the specified buff effect is determined according to the quantity of specified items and the type of the specified item, so that the specified buff effect has a plurality of different effects, and diversity of buff effect display content is improved.

In this embodiment of this application, the attribute value in the attribute slot is displayed synchronously with the buff animation, so that the user can experience a generation process of the specified buff effect more profoundly, which helps improve enthusiasm of the user in performing interactive activities.

In some embodiments, the specified item not only generates the specified buff effect on the first virtual object, but also can generate a debuff effect on the second virtual object. For example, FIG. 15 is a flowchart of a virtual object interaction method according to another exemplary embodiment of this application. As shown in FIG. 15, the method may include the following operations.
Step 1510: Display a first movement animation in response to that display duration of the specified item reaches an item display threshold, the first movement animation being an animation in which the specified item automatically moves toward the first virtual object.

The item display threshold is configured for indicating a display time length after the specified item drops into the virtual scene. In some embodiments, the item display threshold may be a preset fixed value, or the user may freely adjust a range of the item display threshold according to an actual requirement. This is not limited in this embodiment of this application.

In some embodiments, when a specified interactive activity includes a plurality of activity phases, the item display threshold corresponds to an activity phase. If a current activity phase ends and a next activity phase starts, the client displays an animation in which the specified item automatically moves toward the first virtual object in the current activity phase. This ensures that in the latter activity phase, the first virtual object obtains a specified buff effect corresponding to the dropping specified item in the former activity phase. In some embodiments, when the specified item automatically moves toward the first virtual object, display of the first movement animation has been started.

In an example, when the virtual scene includes a plurality of specified items, an animation representation form of the first movement animation includes at least one of the following forms.
1: The first movement animation is implemented as an animation in which the plurality of specified items automatically move toward the first virtual object one by one.
2: The first movement animation is implemented as an animation in which the plurality of specified items automatically move toward the first virtual object simultaneously.

The animation representation forms of the first movement animation are merely an exemplary example. This is not limited in this embodiment of this application.

In some embodiments, when the virtual scene includes the plurality of specified items, the plurality of specified items automatically move toward a same specified location corresponding to the first virtual object. For example, the plurality of specified items automatically move toward a body part of the first virtual object. Alternatively, the plurality of specified items automatically move toward different specified locations corresponding to the first virtual object. For example, the plurality of specified items include an item 1, an item 2, and an item 3. The item 1 automatically moves toward a head of the first virtual object, the item 2 automatically moves toward a body part of the first virtual object, and the item 3 automatically moves toward a leg of the first virtual object.

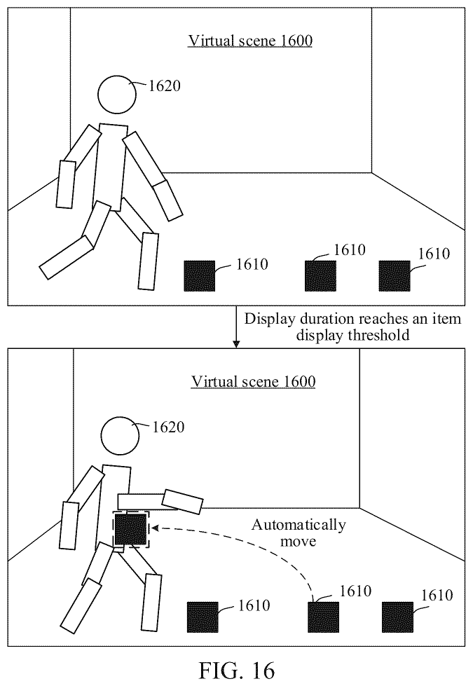

For example, FIG. 16 is a schematic diagram of a first movement animation according to an exemplary embodiment of this application. As shown in FIG. 16, a plurality of specified items 1610 drop into a current virtual scene 1600. When display duration of the specified item 1610 reaches an item display threshold, the specified item 1610 automatically moves toward a first virtual object 1620 as a first movement animation.

In some examples, after displaying the first movement animation, the client displays a buff selection interface at a target location of the specified item. The buff selection interface includes at least two candidate buff effects corresponding to the specified item. The client displays a buff animation corresponding to the first virtual object in response to a trigger operation for a specified buff effect in the at least two candidate buff effects. The buff animation corresponds to the specified buff effect.

For example, a single specified item corresponds to a plurality of different candidate buff effects. After the specified item automatically moves toward the first virtual object (or after the first virtual object picks up the specified item), a buff selection interface corresponding to the specified item is displayed in the virtual scene. The buff selection interface includes at least two candidate buff effects. A user may select a specified buff effect from the candidate buff effects, and the client displays a buff animation corresponding to the first virtual object according to the specified buff effect.

In some embodiments, the client displays a buff animation corresponding to the specified buff effect in response to a trigger operation for the specified buff effect in the at least two candidate buff effects. Alternatively, in response to a trigger operation for a plurality of specified buff effects in the at least two candidate buff effects, the client displays buff animations respectively corresponding to the plurality of specified buff effects. Alternatively, in response to successive trigger operations for a plurality of specified buff effects in the at least two candidate buff effects, the client combines the plurality of specified buff effects to generate a combined buff effect, and displays a buff animation corresponding to the combined buff effect. This is not limited in this embodiment of this application.

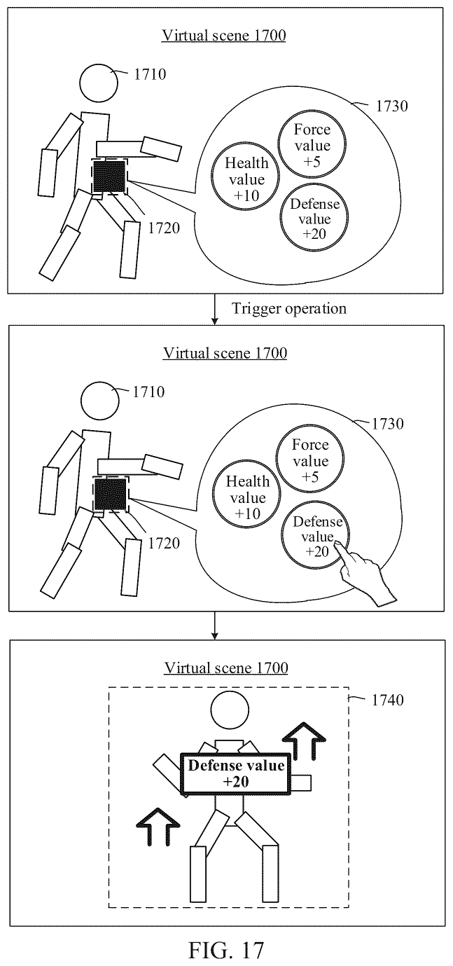

For example, FIG. 17 is a schematic diagram of a buff selection interface according to an exemplary embodiment of this application. As shown in FIG. 17, a virtual scene 1700 includes a first virtual object 1710 and a dropping specified item 1720. When display duration of the specified item 1720 reaches an item display threshold, the specified item 1720 automatically moves toward the first virtual object (not shown in FIG. 17). When the specified item 1720 moves to a body part of the first virtual object 1710, the client displays a buff selection interface 1730. The buff selection interface 1730 includes at least two candidate buff effects (three candidate buff effects are displayed in FIG. 17, and are “a health value plus 10”, “a force value plus 5”, and “a defense value plus 20” respectively). In response to a trigger operation for the specified buff effect “the defense value plus 20” in the at least two candidate buff effects, the client displays a buff animation 1740 corresponding to the specified buff effect “the defense value plus 20”.

In some embodiments, the client displays an automatic buff animation corresponding to the first virtual object in response to that the specified item is in contact with the first virtual object during dropping of the specified item. The automatic buff animation is an animation in which a specified buff effect corresponding to the specified item is generated after the first virtual object is in contact with the specified item.

In some feasible embodiments, in a process in which the special effect text element is converted into the specified item and the specified item drops into the virtual scene, there is a case in which the specified item touches the first virtual object. For example, the specified item is in contact with a head of the first virtual object during dropping of the specified item, and the client displays the automatic buff animation of the first virtual object. The automatic buff animation is an animation in which the specified item generates the specified buff effect corresponding to the specified item on the first virtual object after being in contact with the first virtual object.
Step 1520: Display a second movement animation in response to that display duration of the specified item reaches an item display threshold, the second movement animation being an animation in which the specified item automatically moves toward the second virtual object, and the specified item generating a debuff effect on the second virtual object.

In some embodiments, the item display threshold in step 1520 may be the same as or different from the item display threshold in step 1510. Whether the specified item automatically moves toward the first virtual object or the second virtual object may be fixedly set, or may occur randomly. This is not limited in this embodiment of this application. In some embodiments, when the specified item starts automatically moving toward the second virtual object, display of the second movement animation has been started.

In an example, when the virtual scene includes a plurality of specified items, an animation representation form of the second movement animation includes at least one of the following forms.
1: The second movement animation is implemented as an animation in which the plurality of specified items automatically move toward the second virtual object one by one.
2: The second movement animation is implemented as an animation in which the plurality of specified items automatically move toward the second virtual object simultaneously.

The animation representation forms of the second movement animation are merely an exemplary example. This is not limited in this embodiment of this application.

In some embodiments, the debuff effect is opposite to the buff effect. For example, if the buff effect is a health value plus 10, the debuff effect may be implemented as a health value minus 10.

In some embodiments, for a same specified item, when the specified item generates a first movement animation, the specified item may generate a specified buff effect on the first virtual object, and when the specified item generates a second movement animation, the specified item may generate a debuff effect on the second virtual object. For example, if the specified item is implemented as causing a health value of the first virtual object to be increased by 10, the specified item may be implemented as causing a health value of the second virtual object to be reduced by 10. In some embodiments, the buff effect corresponding to the specified item may not correspond to the debuff effect. This may be set and adjusted according to an actual use requirement. This is not limited in this embodiment of this application.

In an example, when there are a plurality of specified items in the virtual scene, the plurality of specified items generate a debuff effect on the second virtual object as a whole. For example, an item 1 causes an attack power of the second virtual object to be reduced by 10, and an item 2 causes a defense power of the second virtual object to be reduced by 20. Alternatively, when there are a plurality of specified items in the virtual scene, the plurality of specified items may generate different debuff effects on different parts of the second virtual object. This is not limited in this embodiment of this application.

In some feasible examples, the client further displays an integrated item in the virtual scene in response to an item integration operation. The item integration operation is configured for indicating to select at least two specified items for integration. The client integrates the at least two specified items in response to the item integration operation to generate an integrated item, and displays the integrated item in the virtual scene.

In some feasible examples, before the first virtual object picks up the specified item (or in a pick-up process), the client integrates the at least two specified items in the virtual scene in response to the item integration operation, so that the at least two specified items are integrated into one single integrated item for display. That is, the current pick-up operation may indicate the first virtual object to pick up the integrated item. A volume of the integrated item may be implemented as a sum of volumes of all to-be-integrated specified items.

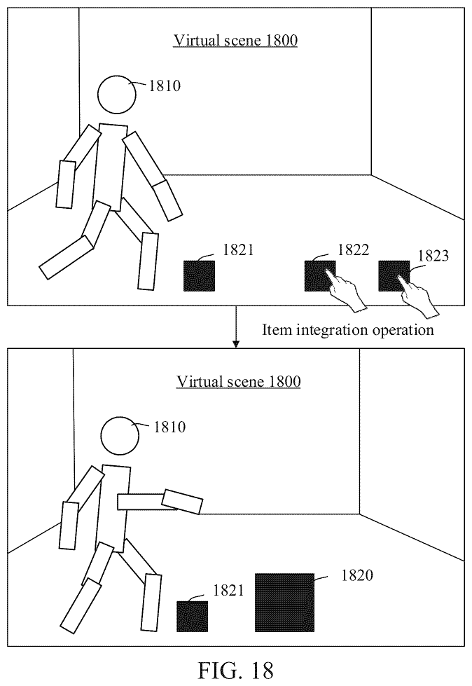

For example, FIG. 18 is a schematic diagram of an item integration process according to an exemplary embodiment of this application. As shown in FIG. 18, a virtual scene 1800 includes a first virtual object 1810 and a plurality of specified items (namely, a specified item 1821, a specified item 1822, and a specified item 1823). In response to an item integration operation on the specified item 1822 and the specified item 1823, the client selects the specified item 1822 and the specified item 1823 for integration, to obtain an integrated item 1820. The client displays the integrated item 1820 in the virtual scene 1800.

In some embodiments, the client may further receive an item trigger operation. The item trigger operation is configured for triggering the specified item to cast a specified skill effect within a skill range. After receiving the item trigger operation, the client displays a skill effect animation. The skill effect animation is an animation in which the specified item casts the specified skill effect within the skill range.

The specified item is implemented as an item casting the specified skill effect. The specified skill effect may include at least one of an attack skill, a defense skill, or the like. In this embodiment of this application, the item trigger operation may be implemented as controlling the first virtual object to attack the specified item. After the specified item is attacked, an animation in which the specified item casts the specified skill effect within a preset skill range is displayed as the skill effect animation.

In some examples, the client may further display an interaction playback animation at a specified location in the virtual scene. The interaction playback animation is a playback animation of the foregoing interactive activity.

For example, when the specified interactive activity includes the plurality of activity phases, after a phased interaction result corresponding to a current activity phase is generated between the first virtual object and the second virtual object in each activity phase, if the first virtual object and the second virtual object start a next activity phase, the client displays a playback animation corresponding to the former activity phase of the first virtual object and the second virtual object at a specified location in the virtual scene.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In this embodiment of this application, the specified item is implemented as corresponding to at least two candidate buff effects. In a manner of selecting a specified buff effect from the at least two candidate buff effects, more options for the specified buff effect may be provided to the user, thereby improving an interaction interest of the user.

In this embodiment of this application, through the automatic buff animation, the specified item can automatically generate the specified buff effect on the first virtual object when the dropping specified item is in contact with the first virtual object, so that human-computer interaction efficiency is improved.

In this embodiment of this application, through the item integration operation, the plurality of specified items may be integrated into the integrated item, so that the first virtual object conveniently picks up the integrated item, and picking efficiency of the first virtual object is improved.

In this embodiment of this application, the first movement animation and/or the second movement animation is displayed, so that an item effect corresponding to the specified item is enriched.

In this embodiment of this application, the interaction playback animation is displayed, so that the user can play back and view the interactive activity in the previous activity phase, and the human-computer interaction efficiency is improved.

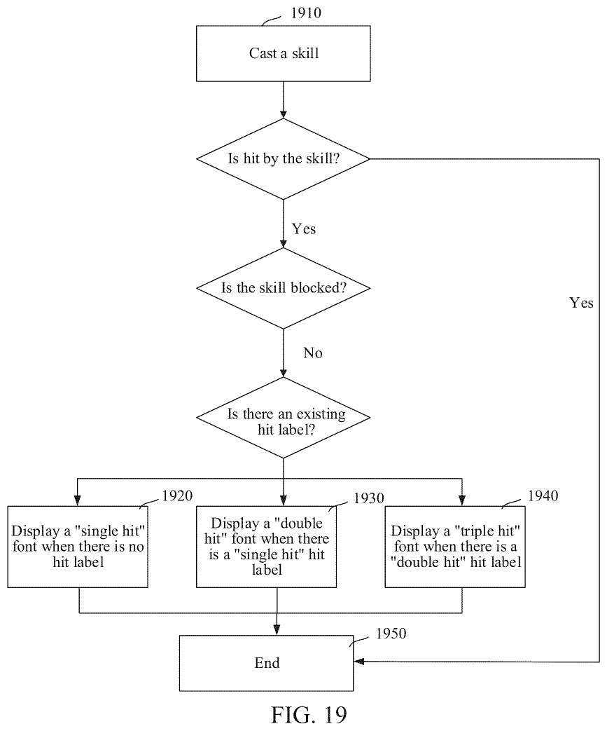

In an exemplary embodiment, each time the first virtual object attacks and hits the second virtual object, the client (or the server) performs label determining. For example, the client determines, based on how many times the current skill hits the second virtual object, a special effect text element that needs to be displayed, and displays a conversion and drop animation corresponding to the special effect text element. FIG. 19 is a flowchart of a virtual object interaction method according to another exemplary embodiment of this application. As shown in FIG. 19, the method includes the following operations.
Step 1910: Cast a skill.

A current virtual environment includes a first virtual object and a second virtual object. The first virtual object and the second virtual object perform a virtual battle in the virtual environment. A player controls the first virtual object to cast a skill to the second virtual object, to attack the second virtual object, that is, the foregoing interactive activity.

When the player controls the first virtual object to cast the skill to the second virtual object and hit the second virtual object, the client first determines whether the hit is blocked by the second virtual object. The block refers to that the skill cast by the first virtual object hits the second virtual object, but the second virtual object uses a block skill to protect the second virtual object from the skill. If the hit skill is not blocked by the second virtual object, the client then determines whether a special effect text element has been displayed in the current virtual scene. The special effect text element is implemented as a hit label. When the first virtual object casts the skill and hits the second virtual object, and the skill hit is not blocked by the second virtual object, it is determined that an activity phase is completed in a current round. A phased interaction result corresponding to the activity phase is that the first virtual object casts the skill and hits the second virtual object.
Step 1920: Display a “single hit” font when there is no hit label.

If no hit label is currently displayed in the virtual scene, there is no case in which the first virtual object casts a skill and hits the second virtual object in the current round. Therefore, the client may display a “single hit” font in the virtual scene according to a hit status in step 1910. The “single hit” font is configured for indicating that the first virtual object hits the second virtual object for the first time in the current round. A process from the current round to the first hit is used as a first activity phase in the current round.
Step 1930: Display a “double hit” font when there is a “single hit” hit label.

If the “single hit” hit label is currently displayed in the virtual scene, there is a case in which the first virtual object casts a skill and hits the second virtual object for the first time in the current round. Therefore, the client may display a “double hit” font in the virtual scene according to the hit status in step 1910. The “double hits” font is configured for indicating that the first virtual object hits the second virtual object for the second time in the current round. A battle process from the first hit to the second hit is used as a second activity phase in the current round.
Step 1940: Display a “triple hit” font when there is a “double hits” hit label.

If the “double hit” hit label is currently displayed in the virtual scene, there is a case in which the first virtual object casts a skill and hits the second virtual object twice in the current round. Therefore, the client may display a “triple hit” font in the virtual scene according to the hit status in step 1910. The “triple hit” font is configured for indicating that the first virtual object hits the second virtual object for the third time in the current round. A battle process from the second hit to the third hit is used as a third activity phase in the current round.
Step 1950: End.

Completion of the interaction process indicates that the first virtual object and the second virtual object complete the battle process in the current round.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

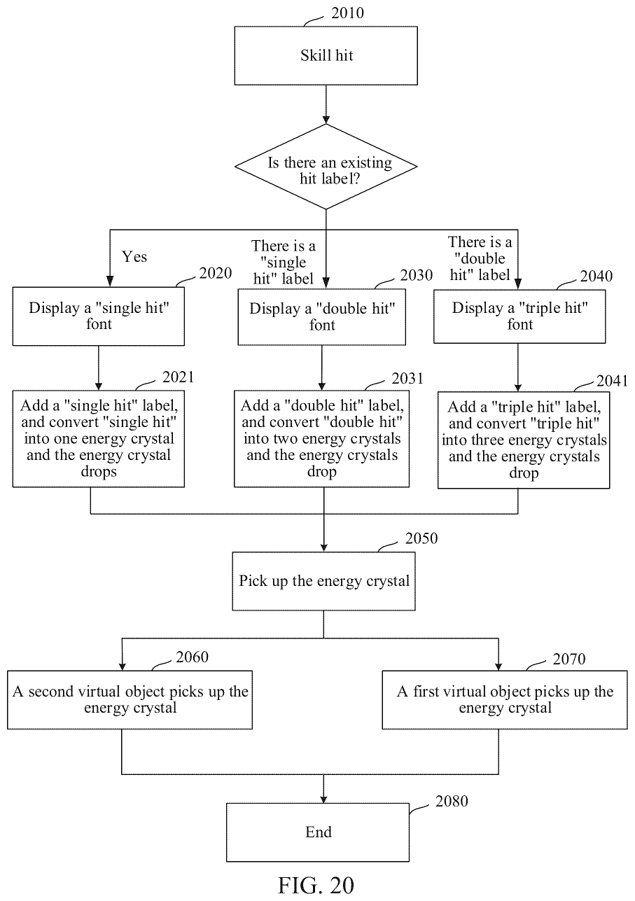

In an exemplary embodiment, a hit label of each level has corresponding display duration. If a hit is caused again during displaying of the hit label, a hit label of a next level is displayed. If a skill hit cannot be caused again within the display duration, display of a special effect text element is canceled, and all hit labels are cleared. After display duration of each special effect text element reaches a display duration threshold, the special effect text element is converted into an energy crystal and the energy crystal drops. After the first virtual object picks up the energy crystal, a specified buff effect is generated on the first virtual object. Different special effect text elements correspond to different quantities of specified items. FIG. 20 is a flowchart of a virtual object interaction method according to another exemplary embodiment of this application. As shown in FIG. 20, the method includes the following operations.
Step 2010: Skill hit.

A virtual scene includes a first virtual object and a second virtual object. In response to an interactive operation, the client controls the first virtual object to perform an interactive activity with the second virtual object in the virtual scene. The interactive activity is implemented as that the two virtual objects perform a virtual battle performed. When the first virtual object casts a skill to the second virtual object and hits the second virtual object, the client determines whether there has been a hit label in the current virtual scene.
Step 2020: Display a “single hit” font

When there is no special effect text element in the virtual scene, that is, when the client does not display any hit label, the client displays a special effect text element of a “single hit” font above the first virtual object.

The “single hit” font is configured for indicating a case in which in the current virtual scene, the first virtual object casts a skill and hits the second virtual object for the first time.
Step 2021: Add a “single hit” label, and convert the “single hit” into one energy crystal and the energy crystal drops.

After the special effect text element of “single hit” font is displayed in the virtual scene, the client correspondingly adds the “single hit” label to the virtual scene, and displays a conversion and drop animation. The conversion and drop animation is implemented as that the special effect text element of “single hit” font is converted into a specified item and the specified item drops into the virtual scene. The specified item is implemented as one energy crystal.
Step 2030: Display a “double hit” font.

When there is the special effect text element of “single hit” font in the virtual scene, that is, when the client has displayed a first hit label “single hit”, the client replaces the special effect text element of “single hit” font above the first virtual object with a special effect text element of “double hit” font for display.

The “double hit” font is configured for indicating a case in which in the current virtual scene, the first virtual object casts a skill and hits the second virtual object for the second time.
Step 2031: Add a “double hit” label, and convert the “double hit” into two energy crystals and the energy crystals drop.

After the special effect text element of “double hit” font is displayed in the virtual scene, the client correspondingly adds the “double hit” label to the virtual scene, and displays a conversion and drop animation. The conversion and drop animation is implemented as that the special effect text element of “double hit” font is converted into a specified item and the specified item drops into the virtual scene. The specified item is implemented as two energy crystals.
Step 2040: Display a “triple hit” font.

When there is the special effect text element of “double hit” font in the virtual scene, that is, when the client has displayed a second hit label “double hit”, the client replaces the special effect text element of “double hit” font above the first virtual object with a special effect text element of “triple hit” font for display.

The “triple hit” font is configured for indicating a case in which in the current virtual scene, the first virtual object casts a skill and hits the second virtual object for the third time.
Step 2041: Add a “triple hit” label, and convert the “triple hit” into three energy crystals and the energy crystals drop.

After the special effect text element of “triple hit” font is displayed in the virtual scene, the client correspondingly adds the “triple hit” label to the virtual scene, and displays a conversion and drop animation. The conversion and drop animation is implemented as that the special effect text element of “triple hit” font is converted into a specified item and the specified item drops into the virtual scene. The specified item is implemented as three energy crystals.
Step 2050: Pick up the energy crystal.

After the energy crystal drops into the virtual scene, both the first virtual object and the second virtual object may pick up the energy crystal. The energy crystal generates different effects on the first virtual object and the second virtual object.
Step 2060: A second virtual object picks up the energy crystal.

When the second virtual object picks up the energy crystal, the energy crystal generates a debuff effect on the second virtual object. Alternatively, the energy crystal does not generate any effect on the second virtual object.
Step 2070: A first virtual object picks up the energy crystal.

When the first virtual object picks up the energy crystal, the energy crystal generates a specified buff effect on the first virtual object.
Step 2080: End.

The foregoing interaction process is completed.

Based on the foregoing, in the virtual object interaction method provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

In addition, according to the technical solutions provided in the embodiments of this application, hit feedback when a player causes the skill hit can be increased, and the player can sense a buff effect after the player causes the skill hit, so that user interaction experience is improved.

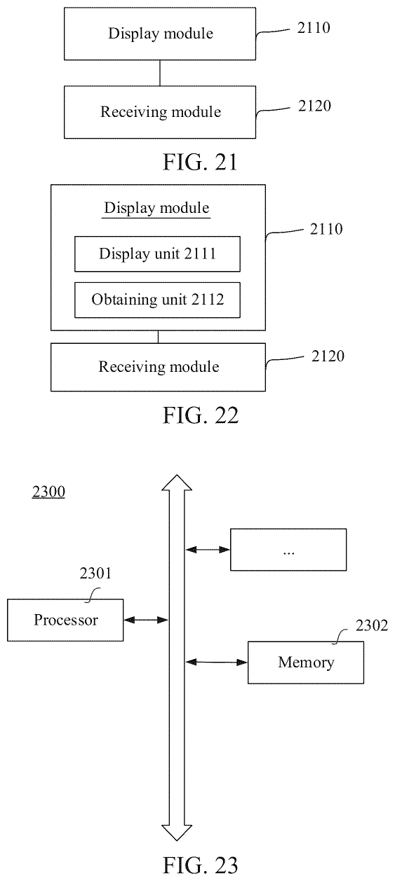

Referring to FIG. 21, FIG. 21 is a structural block diagram of a virtual object interaction apparatus according to an exemplary embodiment of this application. As shown in FIG. 21, the apparatus may include the following parts: a display module 2110 and a receiving module 2120.

The display module 2110 is configured to display a first virtual object and a second virtual object in a virtual scene.

The receiving module 2120 is configured to control, in response to an interactive operation, the first virtual object to perform an interactive activity with the second virtual object in the virtual scene.

The display module 2110 is further configured to display a special effect text element in the virtual scene. The special effect text element corresponds to an interaction result between the first virtual object and the second virtual object.

The display module 2110 is further configured to display a conversion and drop animation of the special effect text element. The conversion and drop animation is an animation in which the special effect text element is converted into a specified item and the specified item drops into the virtual scene.

In some embodiments, the display module 2110 includes: a display unit 2111.

The display unit 2111 is configured to display the conversion and drop animation of the special effect text element based on a specified quantity of specified items. The conversion and drop animation is an animation in which the special effect text element is converted into the specified quantity of specified items and the specified items drop into the virtual scene. The specified quantity corresponds to text content of the special effect text element.

In some embodiments, the interactive activity includes a plurality of activity phases.

The display unit 2111 is further configured to display a special effect text element corresponding to a phased interaction result at a specified location corresponding to the second virtual object in the virtual scene. Text content of the special effect text element corresponds to the phased interaction result, and the phased interaction result is an interaction result in an activity phase.

In some embodiments, the display module 2110 further includes: an obtaining unit 2112.

The obtaining unit 2112 is configured to obtain the specified quantity corresponding to the phased interaction result.

In some embodiments, the display module 2110 is further configured to display the conversion and drop animation of the special effect text element in response to that display duration of the special effect text element reaches a specified duration threshold.

In some embodiments, the interactive activity includes the plurality of activity phases, an i^{th} activity phase corresponds to an i^{th} special effect text element, and i is a positive integer.

The display module 2110 is further configured to display a conversion and drop animation of the i^{th} special effect text element in response to that display duration of the i^{th} special effect text element reaches the specified duration threshold and a phased interaction result corresponding to an (i+1)^{th} activity phase is not received within a range of the specified duration threshold.

In some embodiments, the specified item generates a specified buff effect on the first virtual object.

The receiving module 2120 is further configured to control, in response to a pick-up operation, the first virtual object to pick up the specified item in the virtual scene.
the display module 2110 is further configured to display a buff animation corresponding to the first virtual object. The buff animation is an animation in which the specified buff effect corresponding to the specified item is generated after the first virtual object picks up the specified item. The specified buff effect is related to a quantity of specified items picked up by the first virtual object; or the specified buff effect is related to a type of the specified item picked up by the first virtual object.

In some embodiments, the virtual scene includes an attribute slot corresponding to the first virtual object, and the attribute slot includes an attribute value.

The display module 2110 is further configured to display an attribute value-adding animation corresponding to the first virtual object. The attribute value-adding animation is an animation in which the attribute value increases from an initial attribute value to a target attribute value, and an attribute value increment between the initial attribute value and the target attribute value is related to the specified buff effect.

In some embodiments, the display module 2110 is further configured to:
display a buff selection interface at a target location of the specified item, the buff selection interface including at least two candidate buff effects corresponding to the specified item; and
display a buff animation corresponding to the first virtual object in response to a trigger operation for a specified buff effect in the at least two candidate buff effects, the buff animation corresponding to the specified buff effect.

In some embodiments, the display module 2110 is further configured to display an automatic buff animation corresponding to the first virtual object in response to that the specified item is in contact with the first virtual object during dropping of the specified item. The automatic buff animation is an animation in which a specified buff effect corresponding to the specified item is generated after the first virtual object is in contact with the specified item.

In some embodiments, the receiving module 2120 is further configured to display an integrated item in the virtual scene in response to an item integration operation. The item integration operation is configured for indicating to select at least two specified items for integration.

In some embodiments, the receiving module 2120 is further configured to:
receive an item trigger operation, the item trigger operation being configured for triggering the specified item to cast a specified skill effect within a skill range; and
display a skill effect animation, the skill effect animation being an animation in which the specified item casts the specified skill effect within the skill range.

In some embodiments, the display module 2110 is further configured to display a first movement animation in response to that display duration of the specified item reaches an item display threshold. The first movement animation is an animation in which the specified item automatically moves toward the first virtual object.

In some embodiments, the display module 2110 is further configured to
display a second movement animation in response to that display duration of the specified item reaches an item display threshold. The second movement animation being an animation in which the specified item automatically moves toward the second virtual object, and the specified item generates a debuff effect on the second virtual object.

In some embodiments, the display module 2110 is further configured to:
display a shrinking and disappearing animation of the special effect text element, the shrinking and disappearing animation being an animation in which display of the special effect text element is canceled after the special effect text element shrinks at the specified location corresponding to the second virtual object;
obtain first coordinates of the specified location in a world coordinate system corresponding to the virtual scene as start coordinates of the specified item;
obtain second coordinates corresponding to the first coordinates in the world coordinate system as landing coordinates of the specified item;
obtain drop path data of the specified item based on the first coordinates and the second coordinates; and
display, according to the drop path data, the conversion and drop animation in which the specified item drops.

In some embodiments, the display module 2110 is further configured to:
obtain a texture material set corresponding to the specified item;
obtain, based on an observation perspective of the specified item, a texture material image corresponding to the observation perspective from the texture material set; and
display the texture material image along a drop trajectory corresponding to the drop path data.

Based on the foregoing, in the virtual object interaction apparatus provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

The virtual object interaction apparatus provided in the foregoing embodiments is illustrated with an example of division of the foregoing functional modules. In actual application, the functions may be allocated to and completed by different functional modules according to requirements, that is, the internal structure of the device is divided into different functional modules, to implement all or some of the functions described above. In addition, the virtual object interaction apparatus provided in the foregoing embodiment belongs to the same concept as the virtual object interaction method embodiment. For a specific implementation process of the apparatus, refer to the method embodiment. Details are not described herein again.

In some embodiments, the embodiments of this application may further include the following content.
1. A virtual object interaction method, performed by a terminal device, the method comprising:
displaying a first virtual object and a second virtual object in a virtual scene;
controlling, in response to an interactive operation, the first virtual object to perform an interactive activity with the second virtual object in the virtual scene;
displaying a special effect text element in the virtual scene, the special effect text element corresponding to an interaction result between the first virtual object and the second virtual object; and
displaying a conversion and drop animation of the special effect text element, the conversion and drop animation being an animation in which the special effect text element is converted into a specified item and the specified item drops into the virtual scene.
2. The method according to claim 1, wherein the displaying a conversion and drop animation of the special effect text element comprises:
displaying the conversion and drop animation of the special effect text element based on a specified quantity of specified items, the conversion and drop animation being an animation in which the special effect text element is converted into the specified quantity of specified items and the specified items drop into the virtual scene, wherein
the specified quantity corresponds to text content of the special effect text element.
3. The method according to claim 1 or 2, wherein the interactive activity includes a plurality of activity phases.
the displaying a special effect text element in the virtual scene comprises:
displaying a special effect text element corresponding to a phased interaction result at a specified location corresponding to the second virtual object in the virtual scene, text content of the special effect text element corresponding to the phased interaction result, and the phased interaction result being an interaction result in an activity phase.
4. The method according to any one of claims 1 to 3, wherein the displaying a conversion and drop animation of the special effect text element comprises:
displaying the conversion and drop animation of the special effect text element in response to that display duration of the special effect text element reaches a specified duration threshold.
5. The method according to claim 4, wherein the interactive activity includes the plurality of activity phases, an i^{th} activity phase corresponds to an i^{th} special effect text element, and i is a positive integer.
the displaying the conversion and drop animation of the special effect text element in response to that display duration of the special effect text element reaches a specified duration threshold comprises:
displaying a conversion and drop animation of the i^{th} special effect text element in response to that display duration of the i^{th} special effect text element reaches the specified duration threshold and a phased interaction result corresponding to an (i+1)^{th} activity phase is not received within a range of the specified duration threshold.
6. The method according to any one of claims 1 to 5, wherein the specified item generates a specified buff effect on the first virtual object.
after the displaying a conversion and drop animation of the special effect text element, the method further comprises:
controlling, in response to a pick-up operation, the first virtual object to pick up the specified item in the virtual scene; and
displaying a buff animation corresponding to the first virtual object, the buff animation being an animation in which the specified buff effect corresponding to the specified item is generated after the first virtual object picks up the specified item, wherein
the specified buff effect is related to a quantity of specified items picked up by the first virtual object; or the specified buff effect is related to a type of the specified item picked up by the first virtual object.
7. The method according to any one of claims 1 to 6, wherein a virtual environment includes an attribute slot corresponding to the first virtual object, and the attribute slot includes an attribute value.
the displaying a buff animation corresponding to the first virtual object comprises:
displaying an attribute value-adding animation corresponding to the first virtual object, the attribute value-adding animation being an animation in which the attribute value increases from an initial attribute value to a target attribute value, and an attribute value increment between the initial attribute value and the target attribute value being related to the specified buff effect.
8. The method according to any one of claims 1 to 7, wherein the method further comprises:
displaying a buff selection interface at a target location of the specified item, the buff selection interface including at least two candidate buff effects corresponding to the specified item; and
displaying a buff animation corresponding to the first virtual object in response to a trigger operation for a specified buff effect in the at least two candidate buff effects, the buff animation corresponding to the specified buff effect.
9. The method according to any one of claims 1 to 8, wherein the method further comprises:
displaying an automatic buff animation corresponding to the first virtual object in response to that the specified item is in contact with the first virtual object during dropping of the specified item, the automatic buff animation being an animation in which a specified buff effect corresponding to the specified item is generated after the first virtual object is in contact with the specified item.
10. The method according to any one of claims 1 to 9, wherein the method further comprises:
displaying an integrated item in the virtual scene in response to an item integration operation, the item integration operation being configured for indicating to select at least two specified items for integration.
11. The method according to any one of claims 1 to 10, wherein after the displaying a conversion and drop animation of the special effect text element, the method further comprises:
receiving an item trigger operation, the item trigger operation being configured for triggering the specified item to cast a specified skill effect within a skill range; and
displaying a skill effect animation, the skill effect animation being an animation in which the specified item casts the specified skill effect within the skill range.
12. The method according to any one of claims 1 to 11, wherein the method further comprises:
displaying a first movement animation in response to that display duration of the specified item reaches an item display threshold, the first movement animation being an animation in which the specified item automatically moves toward the first virtual object.
13. The method according to any one of claims 1 to 12, wherein the method further comprises:
displaying a second movement animation in response to that display duration of the specified item reaches an item display threshold, the second movement animation being an animation in which the specified item automatically moves toward the second virtual object, and the specified item generating a debuff effect on the second virtual object.
14. The method according to any one of claims 1 to 13, wherein the displaying a conversion and drop animation of the special effect text element comprises:
displaying a shrinking and disappearing animation of the special effect text element, the shrinking and disappearing animation being an animation in which display of the special effect text element is canceled after the special effect text element shrinks at the specified location corresponding to the second virtual object;
obtaining first coordinates of the specified location in a world coordinate system corresponding to the virtual scene as start coordinates of the specified item;
obtaining second coordinates corresponding to the first coordinates in the world coordinate system as landing coordinates of the specified item;
obtaining drop path data of the specified item based on the first coordinates and the second coordinates; and
displaying, according to the drop path data, the conversion and drop animation in which the specified item drops.
15. The method according to claim 14, wherein the displaying, according to the drop path data, the conversion and drop animation in which the specified item drops comprises:
obtaining a texture material set corresponding to the specified item;
obtaining, based on an observation perspective of the specified item, a texture material image corresponding to the observation perspective from the texture material set; and
displaying the texture material image along a drop trajectory corresponding to the drop path data.

Based on the foregoing, in the virtual object interaction apparatus provided in this embodiment of this application, when a first virtual object performs an interactive activity with a second virtual object, a special effect text element is displayed according to an interaction result, and the special effect text element is converted into a specified item in a form of a conversion and drop animation, so that the interaction result and feeding profit of the interaction result are visualized, thereby improving user interaction experience and increasing diversity of interaction manners between the virtual objects. In addition, the special effect text element is converted into the specified item, and the specified item is provided to the virtual object, so that transfer efficiency of interface display information can be improved. In addition, the interaction result is converted into the specified item, which helps to stimulate interaction between the virtual objects, so that interaction between the virtual objects is improved. This also helps to shorten time of an interactive activity (for example, a game battle), and further reduces a requirement of the game battle for occupation of processing resources of a terminal device and a server.

FIG. 23 is a structural block diagram of a terminal device 2300 according to an exemplary embodiment of this application. The terminal device 2300 may be a smartphone, a tablet computer, an MP3 player, an MP4 player, a notebook computer, or a desktop computer. The terminal device 2300 may also be referred to as another name such as user equipment, a portable terminal, a laptop terminal, or a desktop terminal.

Generally, the terminal device 2300 includes a processor 2301 and a memory 2302.

The processor 2301 may include one or more processing cores, and may be, for example, a 4-core processor or an 8-core processor. The processor 2301 may be implemented in at least one hardware form of a digital signal processor (DSP), a field-programmable gate array (FPGA), and a programmable logic array (PLA). The processor 2301 may alternatively include a main processor and a coprocessor. The main processor is configured to process data in an active state, also referred to as a central processing unit (CPU). The coprocessor is a low-power processor configured to process data in a standby state. In some embodiments, the processor 2301 may be integrated with a graphics processing unit (GPU). The GPU is configured to render and draw content that needs to be displayed on a display screen. In some embodiments, the processor 2301 may further include an artificial intelligence (AI) processor. The AI processor is configured to process computing operations related to machine learning.

The memory 2302 may include one or more computer-readable storage media. The computer-readable storage medium may be non-transient. The memory 2302 may further include a high-speed random access memory and a non-volatile memory, for example, one or more magnetic disk storage devices or flash memory devices. In some embodiments, a non-transient computer-readable storage medium in the memory 2302 is configured to store a computer program, and the computer program is configured to be executed by the processor 2301 to implement the virtual object interaction method provided in the method embodiments of this application.

In some embodiments, the terminal device 2300 further includes another component. A person skilled in the art may understand that the structure shown in FIG. 23 constitutes no limitation to the terminal device 2300, and the terminal device 2300 may include more or fewer components than those shown in the figure, or some components may be combined, or a different component deployment may be used.

A person of ordinary skill in the art may understand that all or some of the steps of the methods in the embodiments may be implemented by a program instructing relevant hardware. The program may be stored in a computer-readable storage medium. The computer-readable storage medium may be the computer-readable storage medium comprised in the memory in the foregoing embodiment, or may be a computer-readable storage medium that exists independently and that is not assembled in a terminal device. The computer-readable storage medium stores a computer program. The computer program is loaded and executed by a processor to implement the virtual object interaction method according to any one of the foregoing embodiments.

In some embodiments, the computer-readable storage medium may include: a ROM, a RAM, a solid state drive (SSD), an optical disc, or the like. The RAM may include a resistance random access memory (ReRAM) and a dynamic random access memory (DRAM). The sequence numbers of the foregoing embodiments of this application are merely for description purpose but do not imply the preference among the embodiments.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

In some embodiments, a computer program product is further provided, including a computer program. The computer program is stored in a computer-readable storage medium. A processor of a terminal device reads the computer program from the computer-readable storage medium and executes the computer program to cause the terminal device to perform the foregoing virtual object interaction method according to any one of the foregoing embodiments.

The foregoing descriptions are merely optional embodiments of this application, but are not intended to limit this application. Any modification, equivalent replacement, or improvement made within the spirit and principle of this application shall fall within the protection scope of this application.

What is claimed is:

1. A virtual object interaction method performed by a computer device, the method comprising:
displaying a first virtual object and a second virtual object in a virtual scene;
in response to an interactive operation by a user of the computer device, controlling the first virtual object to perform an interactive activity with the second virtual object in the virtual scene;
displaying a special effect text element in the virtual scene according to an interaction result between the first virtual object and the second virtual object; and
displaying a conversion and drop animation in which the special effect text element is converted into a specified item and dropped into the virtual scene.

2. The method according to claim 1, wherein the displaying a conversion and drop animation comprises:
displaying the conversion and drop animation based on a specified quantity of specified items corresponding to text content of the special effect text element.

3. The method according to claim 1, wherein the displaying a special effect text element in the virtual scene according to an interaction result between the first virtual object and the second virtual object comprises:
displaying a special effect text element corresponding to a phased interaction result at a specified location corresponding to the second virtual object in the virtual scene, text content of the special effect text element corresponding to the phased interaction result, and the phased interaction result being an interaction result in an activity phase.

4. The method according to claim 1, wherein the displaying a conversion and drop animation comprises:
displaying the conversion and drop animation of the special effect text element in response to that display duration of the special effect text element reaches a specified duration threshold.

5. The method according to claim 1, wherein the specified item generates a specified buff effect on the first virtual object; and the method further comprises:
in response to a pick-up operation by the user of the computer device, controlling the first virtual object to pick up the specified item in the virtual scene; and
displaying a buff animation corresponding to the first virtual object in which the specified buff effect corresponding to the specified item is generated after the first virtual object picks up the specified item, wherein
the specified buff effect is dependent on a quantity of specified items picked up by the first virtual object or a type of the specified item picked up by the first virtual object.

6. The method according to claim 5, wherein the virtual scene comprises an attribute slot corresponding to the first virtual object, and the attribute slot comprises an attribute value; and
the displaying a buff animation corresponding to the first virtual object comprises:
displaying an attribute value-adding animation corresponding to the first virtual object in which the attribute value increases from an initial attribute value to a target attribute value, and an attribute value increment between the initial attribute value and the target attribute value being related to the specified buff effect.

7. The method according to claim 1, wherein the method further comprises:
displaying a buff selection interface at a target location of the specified item, the buff selection interface comprising at least two candidate buff effects corresponding to the specified item; and
displaying a buff animation corresponding to the first virtual object in response to a trigger operation for a specified buff effect in the at least two candidate buff effects, the buff animation corresponding to the specified buff effect.

8. The method according to claim 1, wherein the method further comprises:
displaying an automatic buff animation corresponding to the first virtual object in response to that the specified item is in contact with the first virtual object during dropping of the specified item, the automatic buff animation being an animation in which a specified buff effect corresponding to the specified item is generated after the first virtual object is in contact with the specified item.

9. The method according to claim 1, wherein the method further comprises:
in response to an item integration operation by the user of the computer device to select at least two specified items for integration, displaying an integrated item in the virtual scene.

10. The method according to claim 1, wherein the method further comprises:
in response to that display duration of the specified item reaches an item display threshold, displaying a first movement animation in which the specified item automatically moves toward the first virtual object.

11. The method according to claim 1, wherein the method further comprises:
in response to that display duration of the specified item reaches an item display threshold, displaying a second movement animation in which the specified item automatically moves toward the second virtual object and generates a debuff effect on the second virtual object.

12. The method according to claim 1, wherein the displaying a conversion and drop animation comprises:
displaying a shrinking and disappearing animation in which the special effect text element is canceled after the special effect text element shrinks at the specified location corresponding to the second virtual object;
obtaining first coordinates of the specified location in the virtual scene as start coordinates of the specified item;
obtaining second coordinates corresponding to the first coordinates in the virtual scene as landing coordinates of the specified item;
obtaining drop path data of the specified item based on the first coordinates and the second coordinates; and
displaying, according to the drop path data, the conversion and drop animation in which the specified item drops.

13. The method according to claim 12, wherein the displaying, according to the drop path data, the conversion and drop animation in which the specified item drops comprises:
obtaining a texture material set corresponding to the specified item;
obtaining, based on an observation perspective of the specified item, a texture material image corresponding to the observation perspective from the texture material set; and
displaying the texture material image along a drop trajectory corresponding to the drop path data.

14. A computer device, comprising a processor and a memory, the memory storing a computer program, the computer program, when executed by the processor, causes the computer device to perform a virtual object interaction method including:
displaying a first virtual object and a second virtual object in a virtual scene;
in response to an interactive operation by a user of the computer device, controlling the first virtual object to perform an interactive activity with the second virtual object in the virtual scene;
displaying a special effect text element in the virtual scene according to an interaction result between the first virtual object and the second virtual object; and
displaying a conversion and drop animation in which the special effect text element is converted into a specified item and dropped into the virtual scene.

15. The computer device according to claim 14, wherein the displaying a conversion and drop animation comprises:
displaying the conversion and drop animation based on a specified quantity of specified items corresponding to text content of the special effect text element.

16. The computer device according to claim 14, wherein the displaying a special effect text element in the virtual scene according to an interaction result between the first virtual object and the second virtual object comprises:
displaying a special effect text element corresponding to a phased interaction result at a specified location corresponding to the second virtual object in the virtual scene, text content of the special effect text element corresponding to the phased interaction result, and the phased interaction result being an interaction result in an activity phase.

17. The computer device according to claim 14, wherein the displaying a conversion and drop animation comprises:
displaying the conversion and drop animation of the special effect text element in response to that display duration of the special effect text element reaches a specified duration threshold.

18. The computer device according to claim 14, wherein the specified item generates a specified buff effect on the first virtual object; and the method further comprises:
in response to a pick-up operation by the user of the computer device, controlling the first virtual object to pick up the specified item in the virtual scene; and
displaying a buff animation corresponding to the first virtual object in which the specified buff effect corresponding to the specified item is generated after the first virtual object picks up the specified item, wherein
the specified buff effect is dependent on a quantity of specified items picked up by the first virtual object or a type of the specified item picked up by the first virtual object.

19. The computer device according to claim 14, wherein the method further comprises:
displaying an automatic buff animation corresponding to the first virtual object in response to that the specified item is in contact with the first virtual object during dropping of the specified item, the automatic buff animation being an animation in which a specified buff effect corresponding to the specified item is generated after the first virtual object is in contact with the specified item.

20. A non-transitory computer-readable storage medium storing a computer program therein, the computer program, when executed by a processor of a computer device, causing the computer device to perform a virtual object interaction method including:
displaying a first virtual object and a second virtual object in a virtual scene;
in response to an interactive operation by a user of the computer device, controlling the first virtual object to perform an interactive activity with the second virtual object in the virtual scene;
displaying a special effect text element in the virtual scene according to an interaction result between the first virtual object and the second virtual object; and
displaying a conversion and drop animation in which the special effect text element is converted into a specified item and dropped into the virtual scene.
